(19) United States
(12) Patent Application Publication
(10) Pub. No.: US 2015/0284214 A1
(43) Pub. Date: Oct. 8, 2015

(54) ELEVATOR HEALTH CHECK

(71) Applicant: ThyssenKrupp Elevator AG, Essen (DE)

(72) Inventors: Shawn Park, Atlanta, GA (US); Lindsey Warren, Atlanta, GA (US); Thomas Felis, Atlanta, GA (US)

(21) Appl. No.: 14/679,673

(22) Filed: Apr. 6, 2015

Related U.S. Application Data
(60) Provisional application No. 61/976,038, filed on Apr. 7, 2014.

(51) Int. Cl. B66B 5/00

(52) U.S. Cl. CPC B66B 5/0018; B66B 5/0037; B66B 5/0087

(57) ABSTRACT

A software tool configured on a mobile device can be executed while ascending in an elevator car, causing the device to utilize one or more sensor capabilities, such as an accelerometer or microphone, to capture data relating to the ascent. Captured data can be filtered, manipulated, and combined to generate scores relating to one or more aspects of the elevator car's performance. Scores and captured data can be saved, reviewed and shared via the device.

### CROSS REFERENCE TO RELATED APPLICATIONS

This application is a non-provisional of, and claims the benefit of, U.S. provisional patent application 61/976,038, filed Apr. 7, 2014, having the same title and inventors as this document. The disclosure of that provisional patent application is hereby incorporated by reference in its entirety.

### BACKGROUND

Modern elevator systems have evolved into a complex mix of software-driven machinery and electronics. This complexity has resulted in elevator systems that are efficient, fast, and comfortable for occupants. In order to maintain efficiency and comfort, these complex systems and the hoistways that house them need regular inspection and maintenance so that problems can be identified and resolved. With modern skyscrapers exceeding two thousand feet in height and having a hundred or more individual elevator cars within hoistways, such maintenance and inspection can be a daunting task.

The difficulty in identifying the need for maintenance within an elevator system has been addressed in various ways. Some elevator systems have additional mechanical and electrical sensors that are configured to detect problems and alert system owners. Some tools exist that can be used by a trained technician to detect and diagnose problems. Some elevator systems simply have a point of contact posted so that users can report problems as they arise. However, these various methods for identifying problems can have a significant cost associated with them due to the added mechanical complexity, need for on-site presence of a technician, or inconvenience to the customer. What is needed is an effective, easily used, and easily implemented method for diagnosing the need for maintenance within an elevator system.

### SUMMARY

Disclosed herein is technology that can be used for generating an elevator car health score based upon one or more diagnostic tests performed within or near the elevator car. A low health score would indicate that the system is not performing optimally and may need inspection or upgrade, while a high or acceptable health score would indicate that the system is performing as expected. Using the disclosed technology, performance of the one or more diagnostic tests would, in some embodiments, not require attachment of any additional mechanical or electrical components within the elevator system and would be possible to perform with little or no training.

In one embodiment, the diagnostic tests would be performed by a system owner using a software tool installed on a mobile device such as a tablet or smart phone. The software tool would prompt the user to perform one or more actions and would measure the performance of the elevator in response to the user's one or more actions. For example, one diagnostic test might prompt the user to enter the elevator at the ground floor and press the floor stop button for the highest floor. As the elevator ascends to the top floor, the software tool would use one or more of the mobile device's built in capabilities, such as an accelerometer, microphone, or light sensor to capture information about the elevator's motion, interior sound level, or interior lighting level. In other embodiments, a mobile device may communicate with one or more external sensor devices that are affixed, either temporarily or permanently, to the elevator car, elevator rope, or other elevator system component to provide additional capabilities or more precise measurements.

After collecting information relating to the elevator's performance, the software tool would generate one or more scores relating to individual areas of the elevator's measurable performance. In one embodiment, scores could be generated for the elevator's overall speed, acceleration, jerk, sound level, or lighting level. Scores could be generated relative to industry benchmarks, particular product benchmarks, user feedback benchmarks, or custom benchmarks. After the one or more scores were generated, they could be grouped together with some areas being more heavily weighted than others based upon customer feedback, industry standards, or unique standards, to create hybrid score groups.

Once the overall score is determined, the software tool user could be notified of one or more of the overall scorer or individual scores. A user could utilize the data via the software tool in a number, of ways, for example, a user could choose to save the test results, compare the test results to a prior test, share the results via email or some other means, or discard the results after looking them over.

### BRIEF DESCRIPTION OF THE DRAWINGS

The drawings and detailed description that follow are intended to be merely illustrative and are not intended to limit the scope of protection accorded by this or any related document.

FIG. 1 illustrates an example of high level steps in a method implemented using aspects of the inventors' technology.

FIG. 2 illustrates an example of a set of steps for configuring a software tool for use on a device.

FIG. 3 illustrates an example of a set of steps for performing a test using a software tool.

FIG. 4 illustrates an example of a set of steps for generating score graphs and score calculations based upon data.

FIG. 5 illustrates an example of a set of steps for retaining and utilizing scores, graphs and data.

FIG. 6 shows an example of an interface for interacting with a software tool.

FIG. 7 shows an example of an interface for configuring a software tool.

FIG. 8 shows another example of an interface for configuring a software tool.

FIG. 9 shows yet another example of an interface for configuring a software tool.

FIG. 10 shows an example of an interface for calibrating a software tool and device.

FIG. 11 shows an example of an interface for performing an automated test.

FIG. 12 shows an example of an interface for performing a manual test.

FIG. 13 shows another example of an interface for performing a manual test.

FIG. 14 shows an example of an interface for displaying generates scores.

FIG. 15 shows an example of an interface for displaying captured data.

FIG. 16 shows another example of an interface for displaying captured data.

FIG. 17 shows another example of an interface for displaying captured data.

FIG. 18 shows another example of an interface for displaying captured data.

FIG. 19 shows an example of an interface for configuring metadata.

FIG. 20 shows an example of an interface for saving and selecting data.

FIG. 21 shows an example interface for reviewing data.

FIG. 22 shows an example of an interface for sharing data.

FIG. 23 shows an example of an interface for choosing functionality.

FIG. 24 shows an example of an interface for connecting to a peripheral sensor.

FIG. 25 shows an example of an interface for performing a health check.

FIG. 26 shows an example of an interface for viewing a health check during performance.

FIG. 27 shows an example of an interface for viewing individual health check scores.

FIG. 28 shows an example of an interface for viewing health check information.

FIG. 29 shows an example of an interface for viewing health check information in graph form.

FIG. 30 shows an example of an interface for managing the results of a health check.

FIG. 31 shows an example of an interface for communicating the results of a health check.

FIG. 32 shows a graph plotting elevator speed on the x-axis and a speed score on the y-axis.

FIG. 33 shows a graph plotting elevator acceleration on the x-axis and an acceleration score on the y-axis.

FIG. 34 shows a graph plotting elevator jerk on the x-axis and a jerk score on the y-axis.

FIG. 35 shows a graph plotting elevator vibration on the x-axis and a vibration score on the y-axis.

FIG. 36 shows a graph plotting signal strength on the x-axis and a signal strength score on the y-axis.

FIG. 37 shows a graph plotting sound on the x-axis and a sound score on the y-axis.

FIG. 38 shows a graph plotting temperature on the x-axis and a temperature score on the y-axis.

### DETAILED DESCRIPTION

For the purpose of illustration, the following description sets forth details regarding a software tool and a method that could be performed using the inventors' technology. While this method and associated tool represent preferred embodiments of the inventor's technology, their description should be understood as being illustrative only, and should not be used to limit the scope of protection accorded by this or any related document. Other examples, features, aspects, embodiments, and advantages of the inventors' technology will become apparent to those skilled in the art, and could be implemented by such individuals without undue experimentation, based on the following description. Accordingly, the drawings and descriptions set forth herein should be understood as illustrative only, and should not be used to infer limitations on the protection accorded by any claims included in any patent or application that is related to, or claims the benefit of, this document.

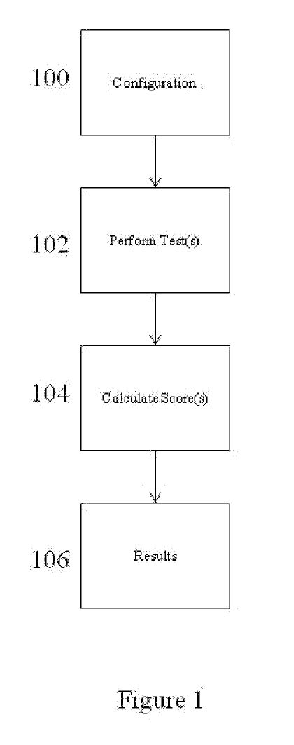

Turning now to the figures, FIG. 1 shows an example of a set of high level steps that could be performed to generate a health score. A software tool can be configured (100) to execute on a device by installing the software tool on the device, configuring the tests to be performed, and configuring the output to be generated. In some embodiments, the configured device will be a smart phone, tablet, laptop, or other mobile computing device having one or more outward facing measuring capabilities. The configured tests will preferably be performed (102) by the device utilizing one or more of its measuring capabilities and the measured data will be recorded and processed for use. After the data has been collected and is ready for use, in the process of FIG. 1, one or more calculations are used to create (104) one or more scores representing the health of a particular aspect of the car. After all scores have been generated, the results (106) are displayed to a user who can then save the scores and data, share the scores and data with a service provider, or compare the scores and data with another data set.

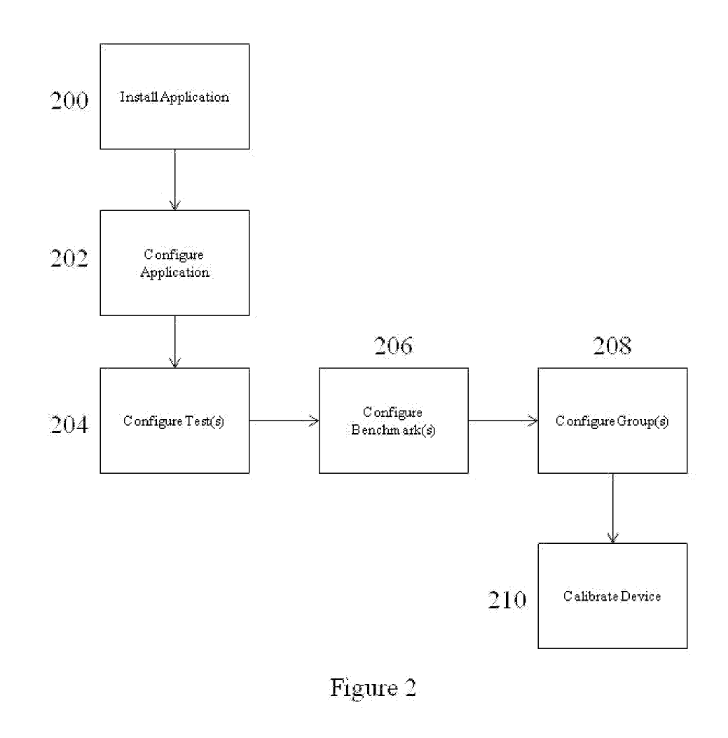

Turning now to FIG. 2, that figure shows an example of a set of steps that could be performed to configure a device to generate a health score. Initially, in the process of FIG. 2, a software tool is installed (200) on the device. For a device such as a smart phone, tablet, laptop, or other portable computing device, the installation (200) could comprise the acquisition and execution of an installer package that would stage the program's executable files and initial data. In one embodiment, this installation (200) would be performed by a user or owner of the device. In another embodiment, this installation would be performed before sale so that the device would be configured (200) with the software upon purchase.

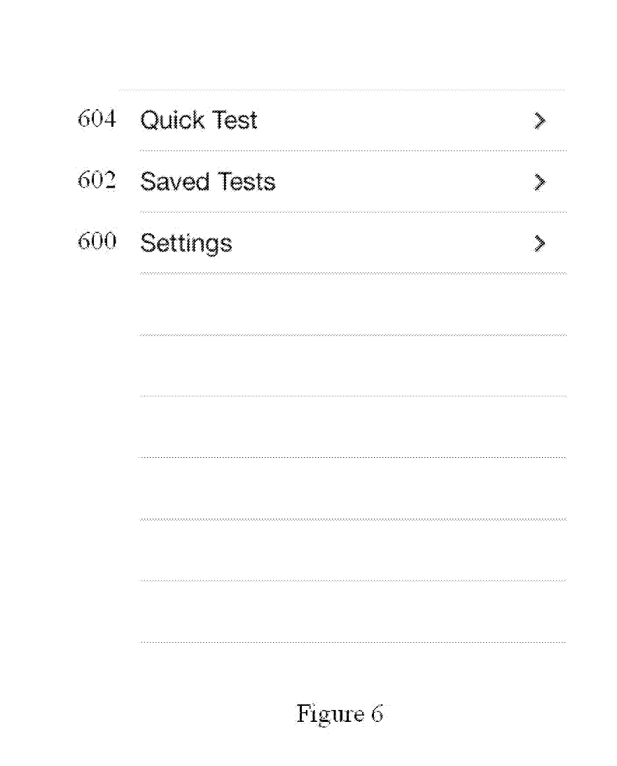

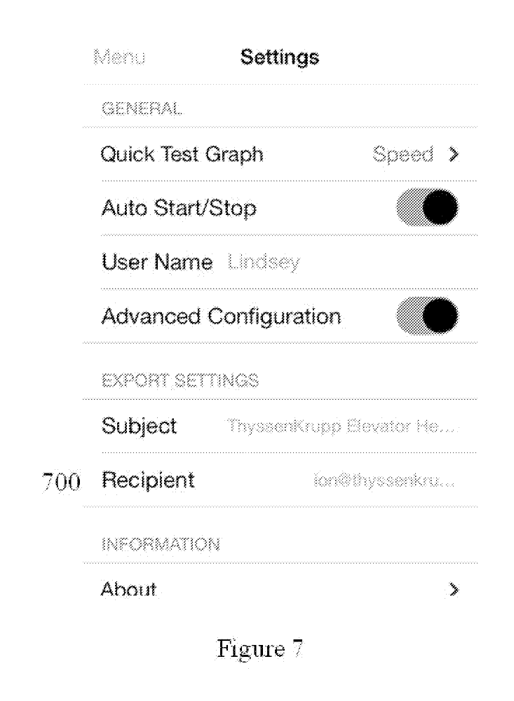

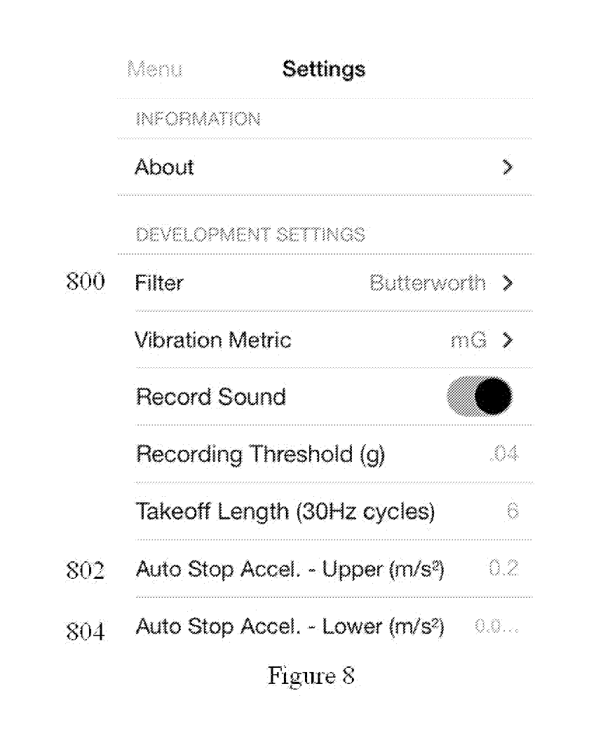

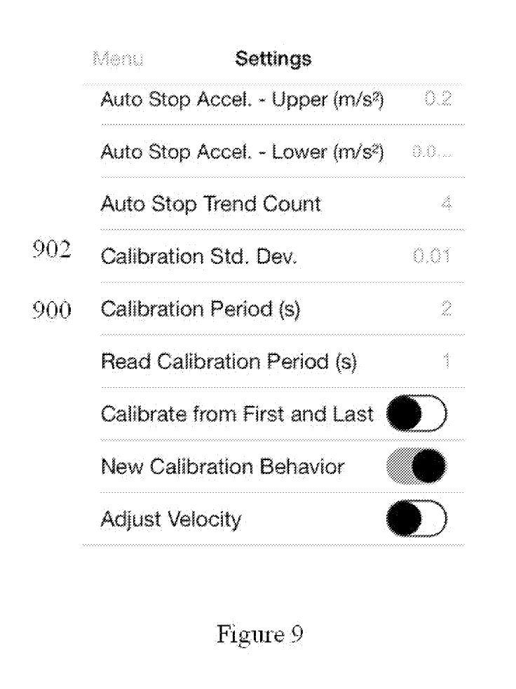

After installation (200), the software tool can be executed to display a user interface that allows a user to complete the configuration (100). FIG. 6 shows an example of such an interface. Via the user interface, a user can enter a settings menu (600) whereby the user can configure the software tool (202), configure the test types and settings (204), configure the scoring benchmarks (206), configure the score weights (208), or calibrate the device (210). FIGS. 7, 8, and 9 each show examples of an interface for configuring the software tool (202). Settings changed here could include, as an example, configuring a recipient for test output (700), configuring a filter to be applied to raw output data (800), configuring an acceleration value for beginning an automatic test (802), configuring an acceleration value for ending an automatic test (804), configuring a calibration period (900), or configuring a calibration standard deviation (902). Once the software tool is configured (202) from within the configuration interface, the configuration is preserved and accessed by the device to control its behavior during other operations.

After installation (200), testing options can be configured (204). One or more tests can be configured (204) depending on the capabilities of the device on which the software tool is installed (200). For example, if the configured device has an accelerometer, one or more tests utilizing the accelerometer will be available to enable or disable. This could include an acceleration test, a maximum speed test, a jerk test, or a vibration test. As another example, if the configured device has a gyroscope, the tests could include an elevator sway test or a ride quality test. As yet another example, if the device has a microphone, the tests could include a sound level test or a sound pitch test. As yet another example, if the device has a light sensor, the tests could include an ambient light test. As yet another example, if the device includes global positioning satellite (“GPS”) capability, the tests could include an ascent speed test or a descent speed test. As yet another example, if the device includes a wireless communication device, the tests could include a signal quality, speed, or continuity test. As yet another example, if the device includes an infrared thermometer or other type of thermometer, the tests could include a temperature comfort test. These sensors and related tests are examples only, and some configured devices may have additional sensors that it would be apparent to enable and use in the manner disclosed herein. In some embodiments, the software tool will come with pre-configured tests (204) rather than allowing a user to enable and disable specific tests.

While the preceding disclosure focused on tests using built in sensors of a device, it should be understood that the disclosed technology is not limited to being in a manner which relies on a device's pre-existing sensors. For example, it is possible that a reusable peripheral sensor could be used to provide sensor capability for a device which either lacked a particular sensor, or which had a sensor which was for some reason unsuitable (e.g., due to a lack of sensitivity). Such reusable peripheral sensors could be attached to the device physically, such as by a universal serial bus cable (“USB”), or could be attached to device wirelessly, such as by Bluetooth wireless communication. Peripheral sensors could also be used which would operate independently of a testing device. Such independent peripheral sensors could include their own power sources, as well as limited memory for storing gathered data before it was uploaded (e.g., to a smartphone or other more capable device) for analysis, and could be placed proximate to the elevator car and attached to a wall, ceiling, floor, exterior car surface, elevator rope, carriage mechanism, or other elevator system component using various fastening approaches such as magnets, suction cups, Velcro, or adhesives, thereby allowing performance data to be gathered without actually requiring a user to be present in the car. Such independent peripheral sensors would preferably be reusable, though it is also possible that they could be permanently installed out of sight within the elevator car or hoistway and could be accessed by one or more users to aid in performing tests.

It should be understood that, in implementations where they are present, reusable peripheral sensors (either independent or otherwise) could take a variety of forms, and have a variety of capabilities. For example, some such sensors could be as simple as a pass-through sensor having only one type of sensor capability, and passing data to the connected device immediately after measuring it. However, it is also possible that such sensors could be more complex, having multiple sensor capabilities as well as other components such as board storage to enable retention of measured data which the sensor could be configured to provide upon connection with a device, and/or a processor which could be used to extrapolate data (e.g., as discussed below) from information directly gathered by the sensor. In this manner, a peripheral sensor could provide raw measurements, such as a measured acceleration over a period of time, but could also process the measured acceleration data in order to calculate velocity over a period of time. Both the raw measurements as well as the calculated measurements could then be communicated to the device, rather than only communicating the raw measurements and relying on the device itself to calculate the extrapolated values.

In one embodiment, a peripheral sensor could be a self-contained device comprising a case, power source, wireless communication capability, and one or more sensing capabilities, such as an accelerometer, thermometer, decibel sensor, signal strength sensor, or other sensor capability. Such a peripheral sensor could be permanently or temporarily placed within an elevator car, on an external surface of an elevator car, on an elevator rope, or on another component of an elevator system. The peripheral sensor could communicate with a device via Bluetooth or other wireless communication and provide measurement data to the device. In some embodiments, the case may have one or more contact points spread across its surface and designed to contact the surface which the peripheral sensor is affixed to in order to ensure precise measurements. In some embodiments, the case may have a spikes, Velcro, or another entanglement or high friction surface that can be used to securely deploy the peripheral sensor on a carpeted surface such as the floor of an elevator car. Other variations on reusable peripheral sensors are also possible, and will be apparent to one of ordinary skill in the art in light of this disclosure.

In some embodiments, a user will also be able to configure scoring benchmarks (206) and score weights (208) that will be used to calculate a score for each test. Configuring a scoring benchmark for one or more tests could comprise selecting a benchmark set from a list of possibilities. One scoring benchmark could be derived from industry standard sources, such as the NEII-1 Building Transportation Standards and Guidelines (“BTSG”), which provides benchmark values for elevator car acceleration, speed, jerk and vibration. As an example, the BTSG provides that a maximum acceptable jerk is 2.44 m/ŝ3. Another example of a benchmark that a user could choose would be an elevator car specific value representing the elevator car's advertised jerk. In this case an elevator could have a manufacturer advertised jerk of 2.0 m/ŝ3. Another example of a benchmark that a user could choose would be a comparison to a different elevator system or technology. In this case, an elevator equipment vendor may configure a maximum jerk of 1.5 m/ŝ3 based upon the capabilities of a new piece of elevator equipment that the vendor is proposing to install in the system that is being tested. In this manner, the benchmarking would provide a comparison point of the existing equipment's performance versus the proposed new equipment's performance. Another example of a benchmark that a user could choose would be a custom benchmark that a user could define as ideal based on their particular circumstances. A jerk of 1.0 m/ŝ3 might be appropriate for a hospital elevator where occupants might be sensitive to physical forces, while a freight elevator might have an ideal jerk of 4.0 m/ŝ3 or more. In some embodiments, the scoring benchmarks might be pre-configured (206) rather than allowing a user to configure and change benchmarks.

Configuring a group (208) would comprise placing one or more tests into one or more groups and giving each test a weighted value within the one or more groups. As an example, a user might place the acceleration score and the speed score into a group representing overall travel time of the elevator, with acceleration being weighted to 75% of the mixed score and acceleration being weighted to the remaining 25% of the mixed score. As a further example, a user might place the jerk score and the vibration score into a group representing passenger comfort during travel, with jerk being weighted to 50% of the mixed score and vibration being weighted to the remaining 50% of the mixed score. As a further example, a user might place the ambient light score and the wireless signal quality score into a group representing passenger convenience during travel, with ambient light score being weighted to 20% of the mixed score and wireless signal quality being weighted to the remaining 80% of the mixed score. These grouped scores could be further grouped, such as by placing the time of travel score and the passenger comfort score into a group representing an elevator's overall score, with each being weighted to 50% of the elevator overall score.

A user's choice to configure groups (208) and assign weights to their component values could be based on different factors. In one embodiment, user feedback and survey results could indicate that some factors are more important than others, resulting in a higher weight for the important factors. In another embodiment, a user could assign weight to factors that are more important for that particular installation, such as assigning a high weight to time of travel for a very tall building, or assigning a high weight to passenger comfort during travel for a hospital or school. In some embodiments the groups and weights would be pre-configured (208) rather than allowing a user to configure and change the groupings.

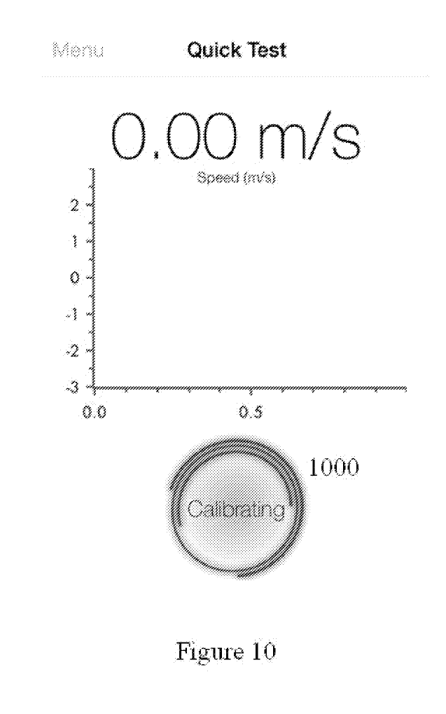

After installation (200), the software tool's interpretation of the device's measuring capabilities can be calibrated (210). Proper calibration (210) can improve the accuracy of the data that the software tool measures on a particular device. FIG. 10 shows an example of an interface for calibrating the software tool for a particular device. As an example, by pressing the calibrate button (1000) and then allowing the device to remain substantially motionless, the software tool could determine the type of data received from the device's accelerometer while the device is at rest and adjust its interpretation of further data received from the accelerometer accordingly. Calibration can also be performed for the device's other built in sensors to determine a standard, such as by calibrating the microphone in relative silence, calibrating the light sensor in a dark room, or calibrating the gyroscope while the device lays flat.

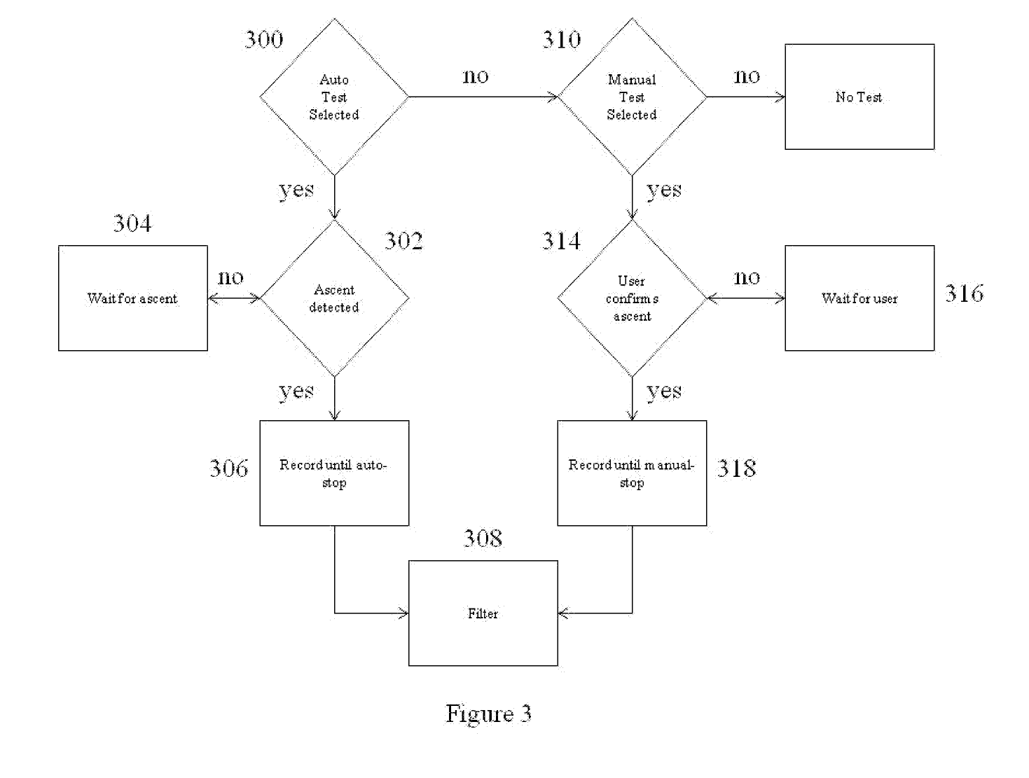

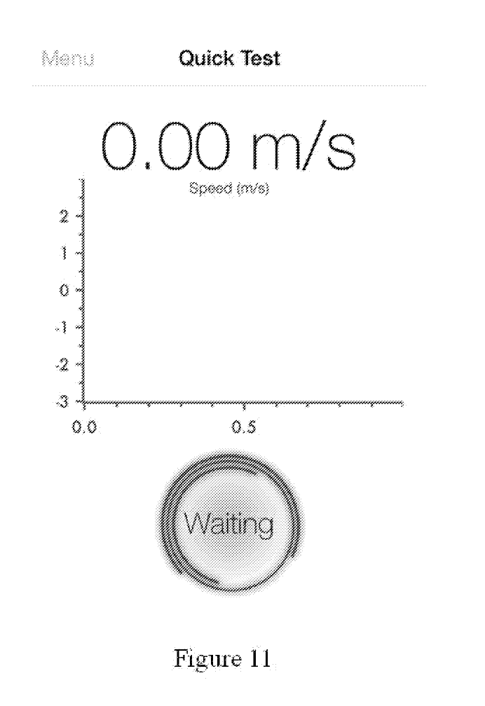

Turning now to FIG. 3, that figure shows an example of a set of steps that could be performed to generate data from one or more tests performed on a device. A user can select to perform an automated test (300) or a manual test (310). If a user chooses to perform the automated test (300), the device will enter a waiting mode (304) until the elevator car begins its ascent (302) or descent. FIG. 11 shows an example of an interface that can be displayed while the device waits (304) for elevator ascent or descent to begin (302). When a user enters the elevator car and makes a floor selection causing the elevator to ascend or descend, the device will detect the ascent (302) or descent using its accelerometer and will cause the device to begin capturing data (306) according to its configuration (100). When the elevator completes its ascent or descent, data capture (306) will cease and one or more signal processing filters (308) can be applied to the raw data. The applied signal processing filter (308) is configurable (202) and could be for example a Butterworth filter, a Chebyshev filter, a Bessel filter, an Elliptic filter, or other filter that a user selects to achieve the desired smoothness.

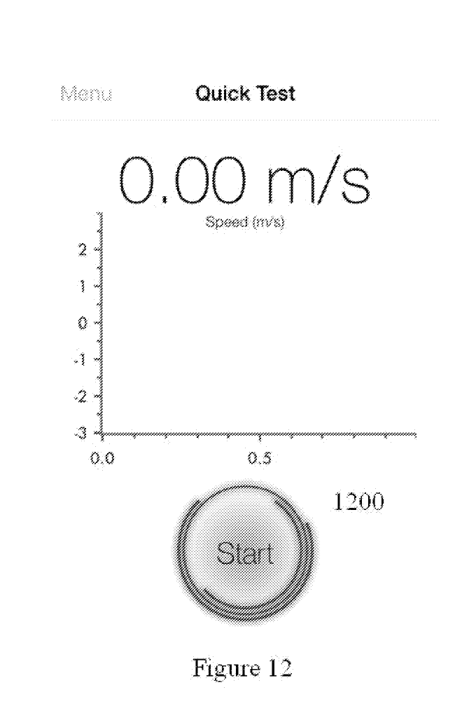

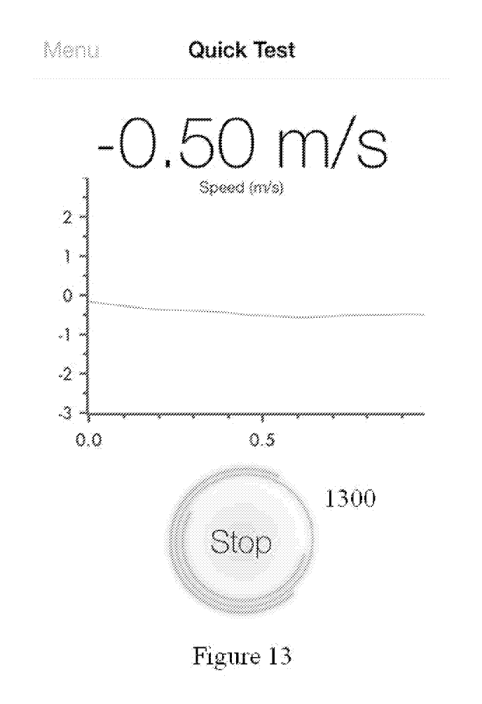

If a user selects a manual test (310), the device will enter a manual waiting mode (316) until the user confirms ascent (314). FIG. 12 shows an example of an interface that can be displayed while the device waits (316) for a user to confirm ascent or descent (314). When a user enters the elevator car and selects a floor to begin the car's ascent or descent, the user can select the start button (1200) to cause the device to begin capturing data (318) according to its configuration (100). In manual mode data capture (318) will continue until a user manually causes it to stop. FIG. 13 shows an example of an interface that can be displayed while the device captures data (318) and that allows a user to manually stop the test by selecting the stop button (1300). Once the manual data capture (318) ceases, one or more signal processing filters (308) can be applied to the raw data.

The recording of data, whether during an automatic test (306) or during a manual test (318), can comprise the capture of raw data directly from a sensor as well as the extrapolation of a new data set based upon a raw data set. For example, a device capturing raw data from an accelerometer will have a data set comprising acceleration and time. The equation for determining velocity as a function of acceleration and time is velocity=initial velocity+acceleration*time. Using the data set from the accelerometer, having acceleration and time, and assuming an initial velocity of zero in an elevator car at rest, velocity can be determined from acceleration during travel. A brief pseudo-code expression follows showing an example of a method which could request acceleration data from a device API and use it to create a velocity data set tracking velocity at approximately 1 second intervals.

TABLE 1
Example algorithm for creating a velocity data
set based upon an acceleration data set

```
  velocity = 0;
  timevelocity = new Array( );
  device = new DeviceAPI( );
T
  while (testing == true){
u
r
  currentcccel = device.getAccel( );
n
  velocity = velocity + currentaccel;
i
n
  timevelocity.add(velocity);
g
  sleep (1);
n
  }
```

Similarly, the equation for determining jerk as a function of acceleration and time is Δ a/Δ t, or, the change in acceleration over the change in time. Using the data set from the accelerometer, having acceleration and time, jerk can be determined during travel. A brief pseudo-code expression follows showing an example of a method which could request acceleration data from a device API and use it to create a jerk data set tracking jerk at approximately 1 second intervals.

TABLE 2
Example algorithm for creating a jerk data
set based upon an acceleration data set

```
  currenttime = 0;
  timejerk = new Array( );
  device = new DeviceAPI( );
  previousaccel = device.getAccel( );
T
u
  while (testing == true){
r
n
  currentaccel = device.getAccel( );
i
  jerk = absoluteval(previousaccel − currentaccel);
n
  timejerk.add(jerk);
g
  previousaccel = currentaccel;
n
  sleep (1);
o
  }
```

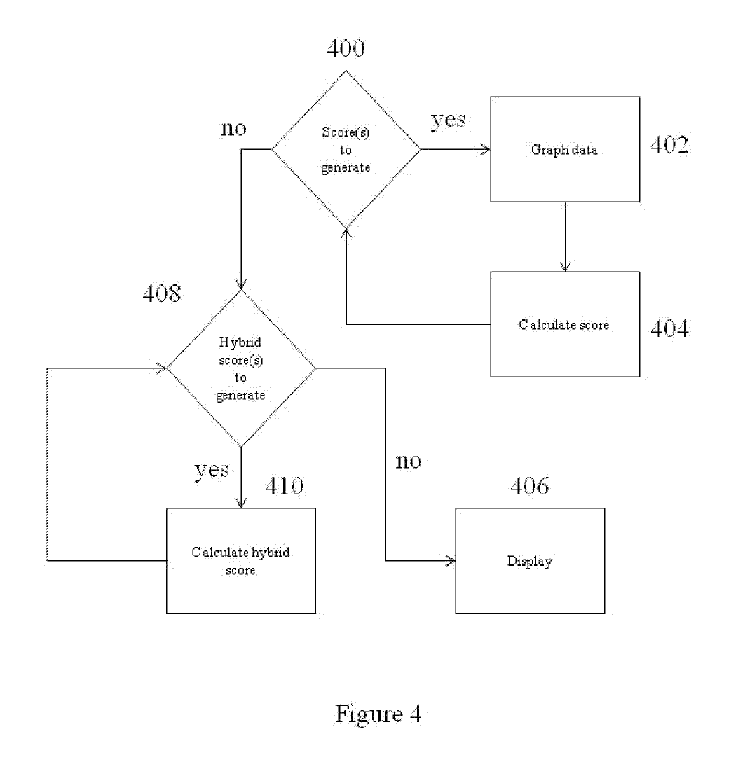

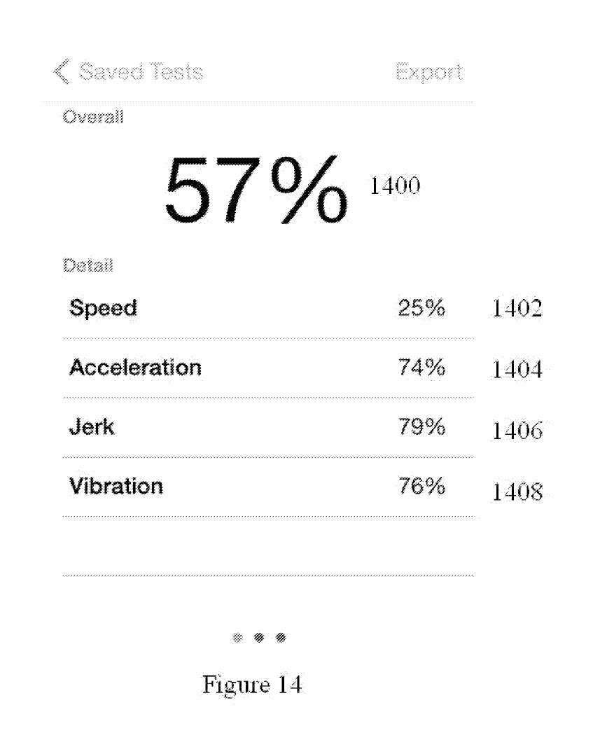

Turning now to FIG. 4, that figures shows an example of a set of steps that could be performed to generate one or more scores from one or more captured data sets. Once an automatic test (300) or manual test (310) has been performed resulting in data being captured, the software tool may, depending on its testing configuration (204), have one or more scores to generate based upon the captured data (400). For each score that should be generated, the software tool will generate a graph of the data (402) and then calculate the score (404). After calculating a base set of scores (404), the software tool will calculate (410) any hybrid score groups that it is configure to generate (408). Once all base scores, hybrid scores, and graphs have been generated, the software tool will display the results via the device display. FIG. 14 shows an example of an interface that could be used to display generated scores (404). An overall score (1400) would be shown along with the individual scores that are combined together to arrive at the overall score. In this embodiment the individual scores for speed (1402), acceleration (1404), jerk (1406), and vibration (1408) are used to determine the overall score (1400), but it is apparent in light of this disclosure that other combinations of scores exist and that these are just one example.

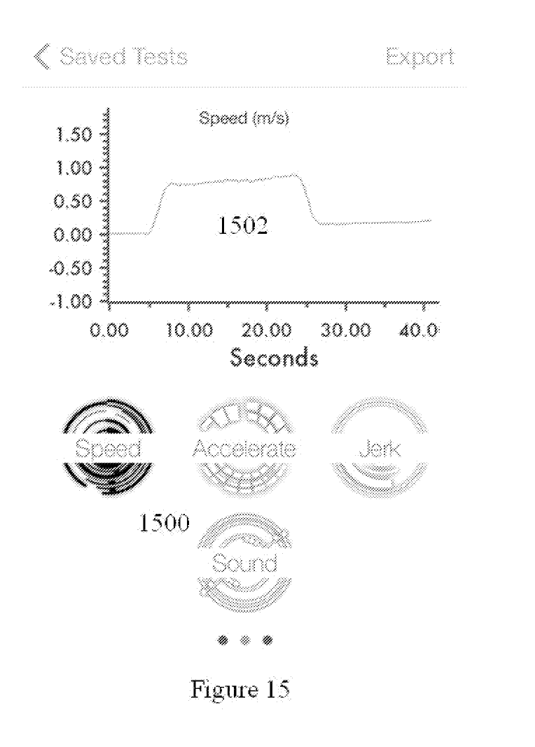

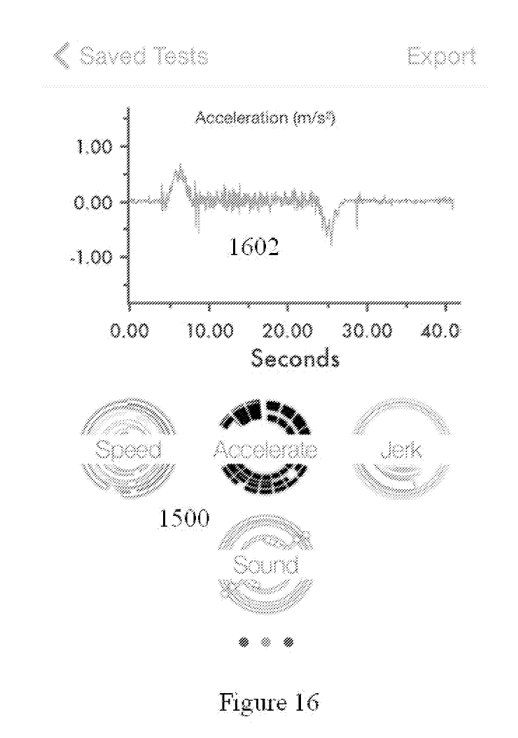

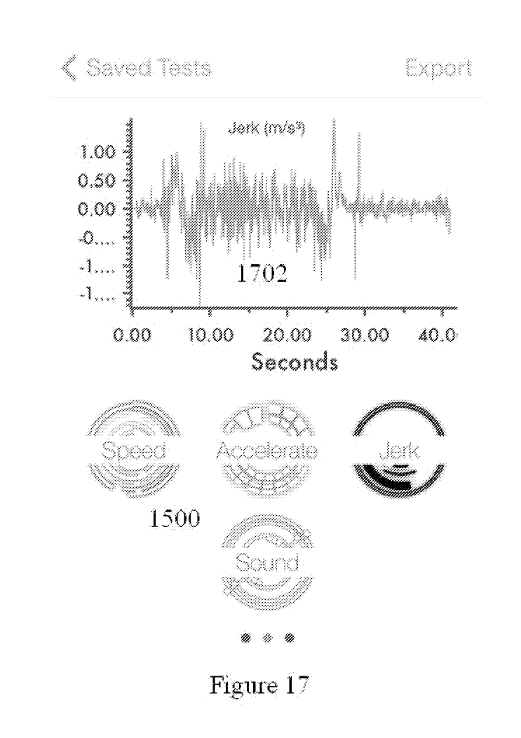

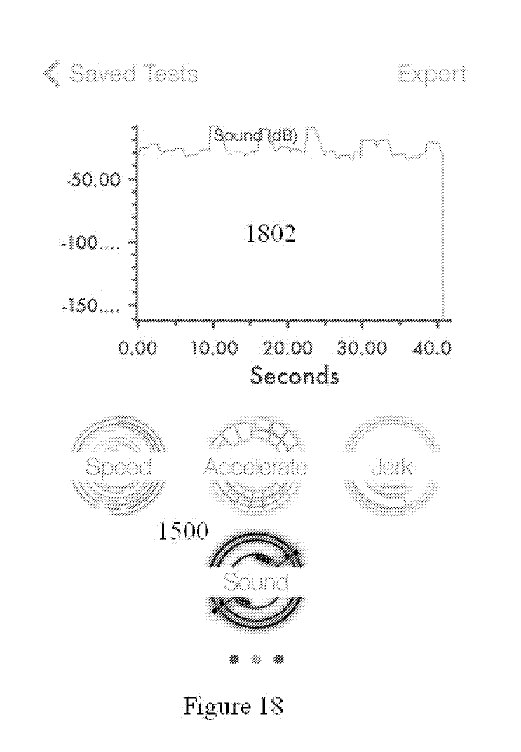

FIGS. 15-18 show an example of an interface that could be used to display the graphed data (402) associated with the generated scores. A user could select buttons (1500) to switch between data graphs. A graph could be shown for one or more of the captured data types. These graphs could include, for example, a graph showing the speed over time (1502) as detected by an accelerometer during ascent, a graph showing acceleration over time (1602) as detected by the accelerometer, a graph showing jerk over time (1702) as detected by the accelerometer, or a graph showing sound intensity over time (1802) as detected by a microphone.

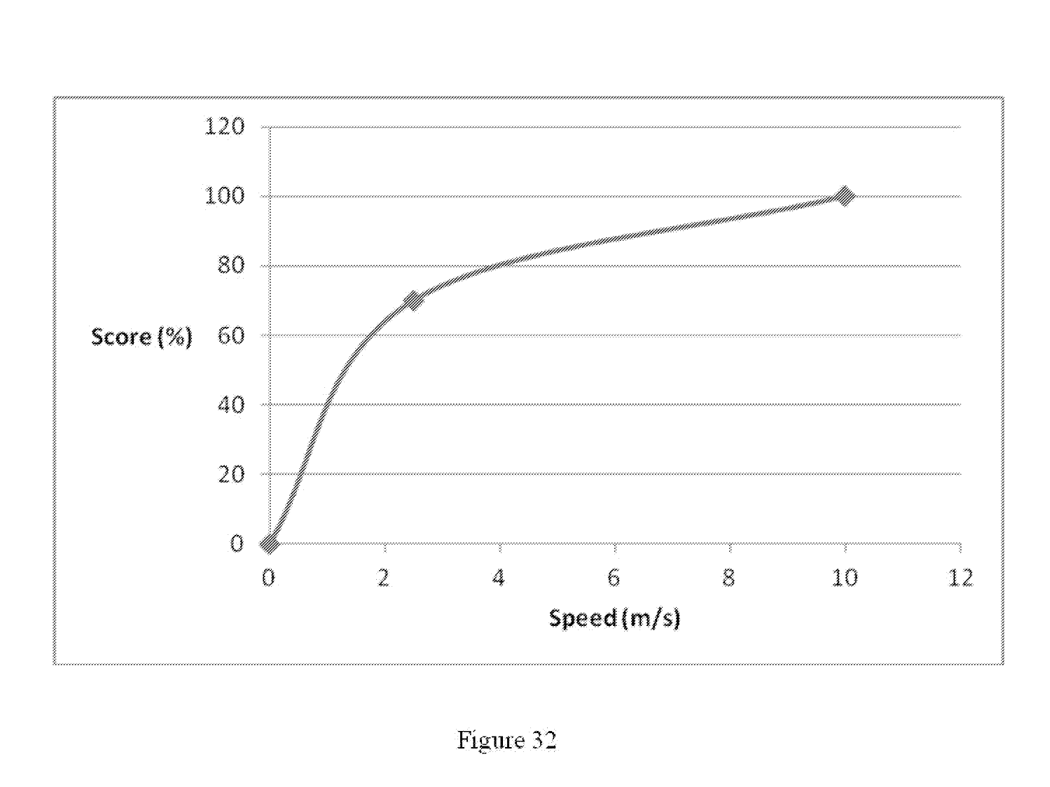

The precise steps for calculating of scores (404) can vary based upon the aspect of the elevator being scored as well as the benchmark that is being used as a comparison. As an example, when generating a score based upon the measured speed data of an elevator, the benchmarking standard might provide that 10 meters per second (“m/s”) is the perfect elevator speed, resulting in a score of 100%, while a speed of 2.5 m/s is an acceptable elevator speed, resulting in a score of 70%. A set of equations that could be used to generate a graph and range of scores between 0% and 100% based upon these benchmarks is y=−7x̂2+45x for values below 2.5 m/s, and y=50 log(x)+50 for values equal to or above 2.5 m/s, where y is the resulting score and x is the speed in m/s measured by the device. FIG. 32 shows a graph plotting the example equations, where the x-axis is speed and the y-axis is a speed score. The variable x could be taken as the device's maximum speed, average speed, or the most common speed throughout the ascent or descent, as an example.

TABLE 3
Example range of speed scores calculated using
y = −7x\hat{ }2 + 45x and y = 50log(x) + 50

| Speed (m/s) | Score |
|---|---|
| 0 | 0 |
| 1 | 38 |
| 2 | 62 |
| 2.5 | 70 |
| 4 | 80 |
| 8 | 95 |
| 10 | 100 |

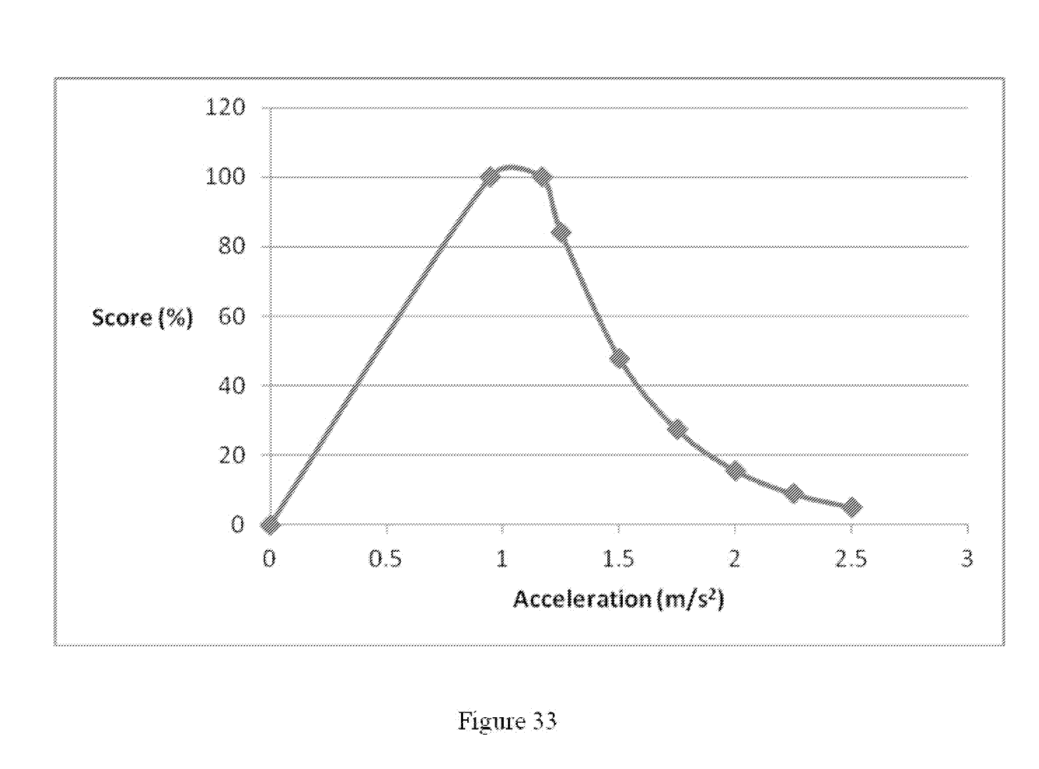

In one embodiment that generates an acceleration score based on the measured acceleration data of an elevator, a benchmarking standard might be the BTSG acceleration target zone of 1.06 meters per second squared (m/ŝ2), with a variance of 10%. A score of 100% would be assigned to acceleration values between 0.954 m/ŝ2 and 1.166 m/ŝ2, with values below the range linearly decreasing to 0% and values above the range exponentially decreasing to 0%. An equation that could be used to generate the proper range of scores could be y=104.8x for values below 0.954 m/ŝ2 and y=1400ê−2.25x for values above 1.166 m/ŝ2, where y is the resulting score and x is the acceleration in m/ŝ2 measured by the device. FIG. 33 shows a graph plotting the example equation, where the x-axis is acceleration and the y-axis is an acceleration score. The variable x could be determined by taking the average acceleration, maximum acceleration, or most common acceleration value from the data set.

TABLE 4
Example range of acceleration scores calculated
using y = 104.8x and y = 1400e\hat{ } − 2.25x

| Acceleration (m/s\hat{ }2) | Score |
|---|---|
| 0 | 0 |
| .945 | 100 |
| 1.166 | 100 |
| 1.25 | 84 |
| 1.5 | 48 |
| 1.75 | 27 |
| 2 | 16 |
| 2.25 | 9 |
| 2.5 | 5 |

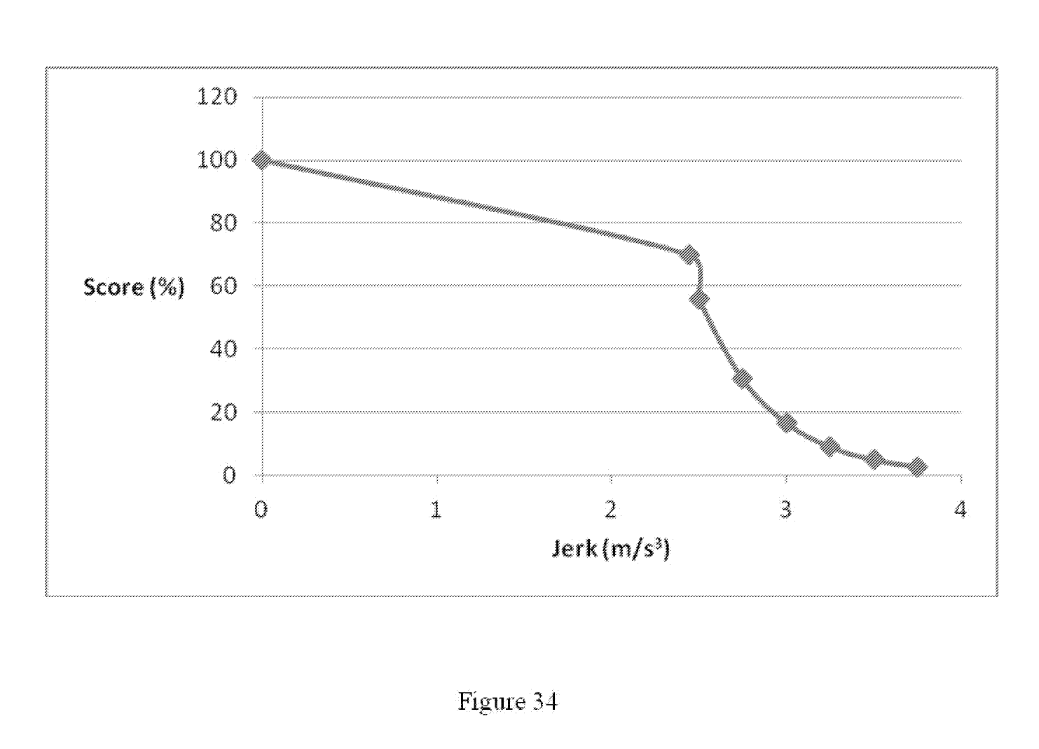

In one embodiment that generates a jerk score based on the measured jerk data of an elevator, a benchmarking standard might be the BTSG maximum acceptable jerk of 2.44 meters per second cubed (m/ŝ3). A score of 70% could be assigned to the maximum acceptable jerk, with the score linearly decreasing from 100% at zero jerk to 70% at 2.44 m/ŝ3 jerk, and then exponentially decreasing from 70% to 0%. An equation that could be used to generate the proper range of scores could be y=100−12.3x for values less than 2.44 m/ŝ3 and y=27000ê−2.45x for values greater than 2.44 m/ŝ3, where y is the resulting score and x is the jerk in m/ŝ3 measured by the device. FIG. 34 shows a graph plotting the example equation, where the x-axis is jerk and the y-axis is a jerk score. The variable x could be determined by taking the average jerk, maximum jerk, or most common jerk value from the data set.

TABLE 5
Example range of jerk scores calculated
using y = 27000e\hat{ } − 2.45x

| Jerk (m/s\hat{ }3) | Score |
|---|---|
| 0 | 100 |
| 2.44 | 70 |
| 2.5 | 56 |
| 2.75 | 30 |
| 3 | 17 |
| 3.25 | 9 |
| 3.5 | 5 |
| 3.75 | 3 |

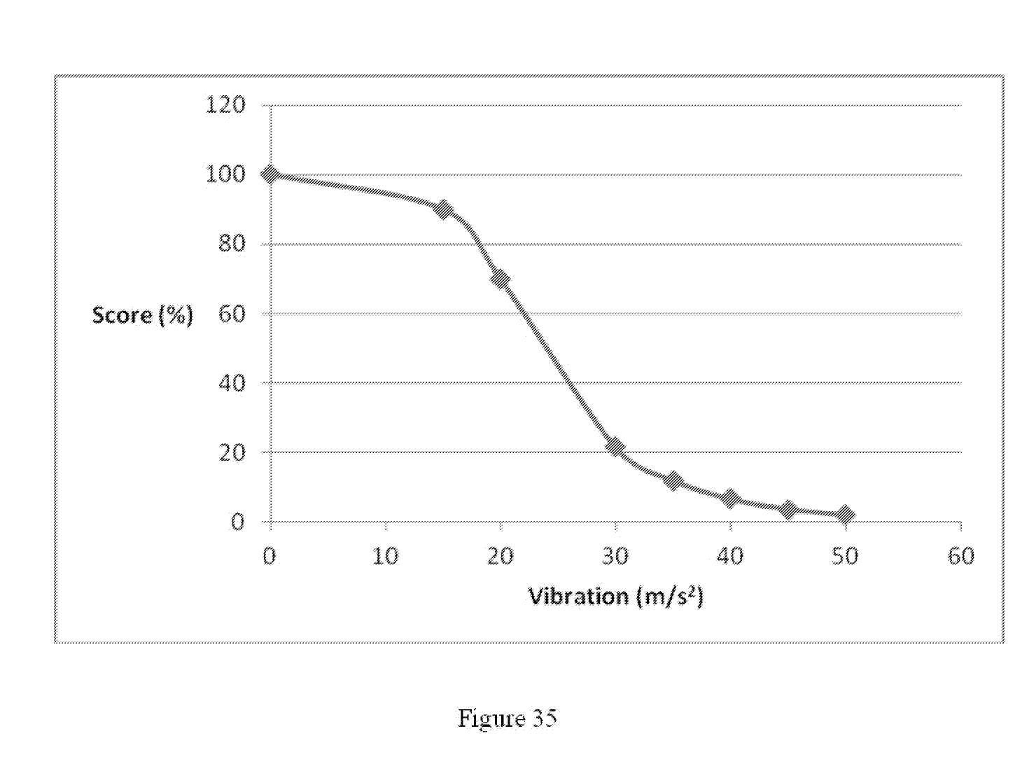

In one embodiment that generates a vibration score based on the measured vibration data of an elevator, a benchmarking standard might be the BTSG standard for acceptable vibration intensity of 20 milli-g at 8 Hz. Of course, different benchmarks are also possible. For example, ISO frequency weighing standards which may now exist or which may be promulgated in the future could provide different frequencies than 8 Hz as the frequencies that humans are most sensitive to in the horizontal and/or vertical axes, and the intensity of vibrations at these frequencies could be used in determination a vibration score, rather than the intensity at 8 Hz as described above. Whatever vibration frequency (or frequencies) is (or are) used, in embodiments where an intensity of 20 milli-g is treated as acceptable, a score of 70% could be assigned to the acceptable vibration intensity of 20 milli-g, with the score exponentially decaying from 100% at zero vibration to 70% at 20 milli-g, and eventually to 0%. An equation that could be used to generate the proper range of scores could be y=7.33.15ê−11.3x, where y is the resulting score and x is the vibration intensity in milli-g measured by the device. FIG. 35 shows a graph plotting the example equation, where the x-axis is vibration and the y-axis is a vibration score. The variable x could be determined by taking the average intensity, maximum intensity, or most common intensity value from the data set.

TABLE 6
Example range of vibration scores calculated
using y = 733.15e\hat{ } − 11.3x

| Vibration intensity (milli-g) | Score |
|---|---|
| 0 | 100 |
| 15 | 90 |
| 20 | 70 |
| 30 | 26 |
| 35 | 15 |
| 40 | 9 |
| 45 | 5 |
| 50 | 3 |

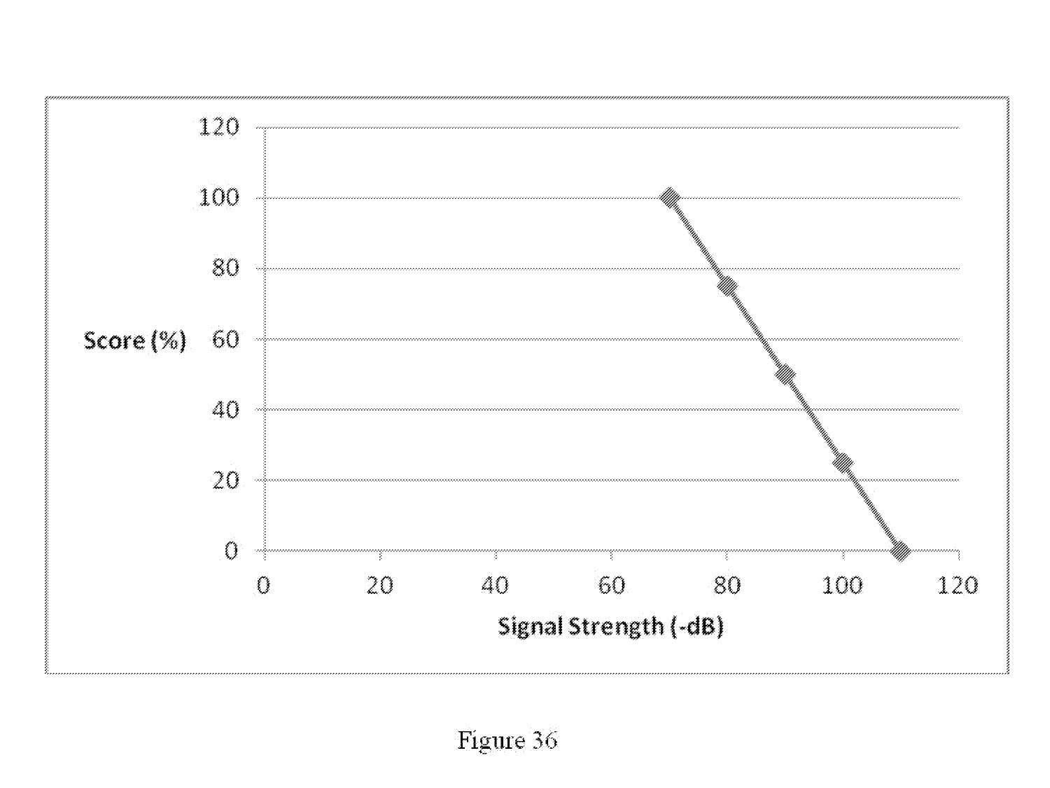

In one embodiment that generates a signal strength score based on the measured mobile signal while in an elevator, a benchmarking standard might be a custom-configured ideal signal strength of −70 dB. A score of 100% could be assigned to the ideal strength of −70 dB, decreasing linearly to 0%. An equation that could be used to generate the proper range of scores could be y=−2.5x+275, where y is the resulting score and x is the signal strength in negative decibels measured by the device. FIG. 36 shows a graph plotting the example equation, where the x-axis is signal strength and the y-axis is a signal strength score. The variable x could be determined by taking the average signal strength, maximum signal strength, minimum signal strength, or most common signal strength value from the data set.

TABLE 7
Example range of signal strength scores
calculated using y = −2.5x + 275

| Signal Strength (−dB) | Score |
|---|---|
| 70 | 100 |
| 80 | 75 |
| 90 | 50 |
| 100 | 25 |
| 110 | 0 |

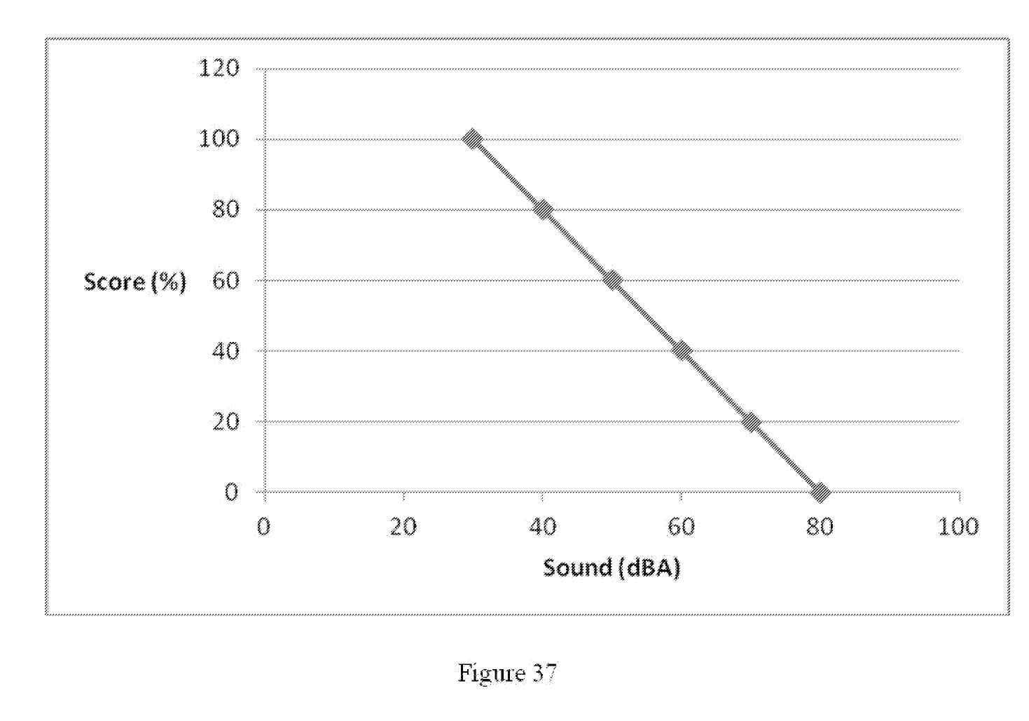

In one embodiment that generates a sound intensity score based on the measured sound level while in an elevator, a benchmarking standard might be a custom configured ideal sound intensity of 30 A weighted decibels. A score of 100% could be assigned to the ideal sound intensity of 30 dBA, decreasing linearly to 0%. An equation that could be used to generate the proper range of scores could be y=−2x+160, where y is the resulting score and x is the sound intensity in A weighted decibels measured by the device. FIG. 37 shows a graph plotting the example equation, where the x-axis is sound and the y-axis is a sound score. The variable x could be determined by taking the average sound intensity, maximum sound intensity, or most common sound intensity value from the data set.

TABLE 8
Example range of sound intensity scores
calculated using y = −2x + 160

| Sound intensity (−dBA) | Score |
|---|---|
| 30 | 100 |
| 40 | 80 |
| 50 | 60 |
| 60 | 40 |
| 70 | 20 |
| 80 | 0 |

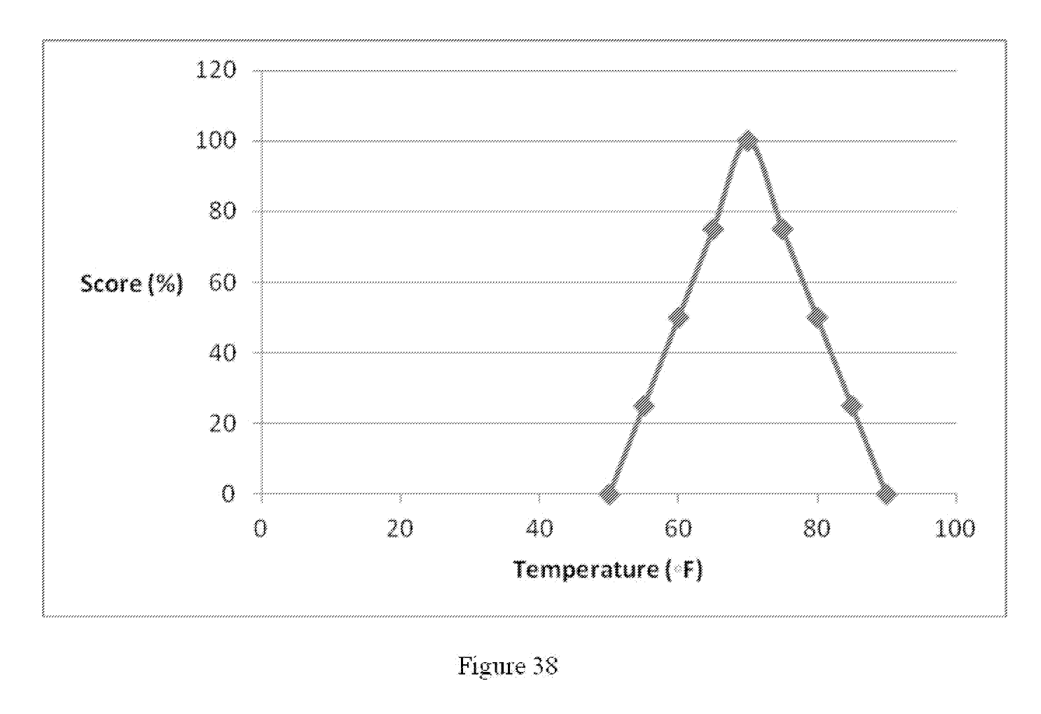

In one embodiment that generates a temperature score based on the measured temperature while in an elevator, a benchmarking standard might be a custom configured ideal temperature of 70 degrees Fahrenheit. A score of 100% could be assigned to the ideal temperature of 70 F, decreasing linearly to 0% as temperature rises above or falls below 70 F. An equation that could be used to generate the proper range of scores could be y=5x−250 for temperatures below 70 F, or y=−5x−450 for temperatures above 70 F, where y is the resulting score and x is the temperature in degrees Fahrenheit measured by the device. FIG. 38 shows a graph plotting the example equation, where the x-axis is temperature and the y-axis is a temperature score. The variable x could be determined by taking the average temperature, maximum temperature, minimum temperature, or most common temperature value from the data set.

TABLE 9
Example range of temperature scores calculated
using y = 5x − 250 and y = −5x − 450

| Temperature (F) | Score |
|---|---|
| 50 | 0 |
| 55 | 25 |
| 60 | 50 |
| 70 | 100 |
| 75 | 75 |
| 80 | 50 |
| 85 | 25 |
| 90 | 0 |

In one embodiment that generates a lighting score based on the measured light while in an elevator, a benchmarking standard might be a custom configured ideal ambient light level of 500 lux. A score of 100% could be assigned to the ideal ambient light of 500 lux, decreasing linearly to 0% as ambient light rises above or falls below 500 lux. An equation that could be used to generate the proper range of scores could be y=0.2x for ambient lighting below 500 lux, or y=−0.2x+200 for ambient lighting above 500 lux, where y is the resulting score and x is the ambient lighting in lux measured by the device. The variable x could be determined by taking the average lighting, maximum lighting, minimum lighting, or most common lighting value from the data set.

In light of the examples disclosed above, other test scores for aspects of an elevator car or elevator system will be apparent. Also apparent is the flexibility in functions available for generating a scoring graph. While some score examples decay exponentially and some decay linearly, either type of decay could provide meaningful scoring results for any of the tests. For example, an ambient lighting test could provide meaningful scoring results if it were to decay exponentially from 100% at 500 lux to 0% at 1000 lux. The equations provided as examples could also be varied to cause their score to decay more or less rapidly at certain points in the graph to reflect, for example, user feedback indicating that while 500 lux is ideal, 750 lux is not uncomfortable, and that users only begin to feel discomfort above 750 lux. The variety of equations and benchmarks that could be used to calculate scores and create scoring graphs will be apparent to one of ordinary skill the art in light of this disclosure.

One or more of the above scores (404) might be combined into groups representing hybrid scores according to the software tool configuration (208). In one embodiment, the software tool could be configured to generate an overall score (1400) from a combination of a speed (1402), acceleration (1404), jerk (1406), and vibration (1408) score. The equation for this combination could be a simple average, but could also vary by embodiment and configuration to give greater weight to one attribute over another. In one embodiment, speed (1402) and acceleration (1404) would be combined together to create a hybrid time of travel score, with speed being weighted at 75%, perhaps in response to customer feedback indicating that speed is more important than acceleration, and acceleration being weighted at 25%. An equation for calculating time of travel score would be (speed*0.75)+(acceleration*0.25). In this embodiment, jerk (1406) and vibration (1408) would be combined together to create a hybrid occupant comfort score, with each being weighted at 50%. An equation for calculating occupant comfort score would be (jerk*0.5)+(vibration*0.5). In this embodiment, time of travel score and occupant comfort score could be combined into yet another hybrid score, representing an overall score (1400), with each being weighted at 50%. An equation for calculating overall score would be (time of travel*0.5)+(occupant comfort*0.5).

While hybrid group scores can be useful in some embodiments they are not necessary. An alternative embodiment of an equation for calculating an overall score, not relying on hybrid group scores, could be a weighted combination of a plurality of individual scores. For example, in the context of an elevator system serving a counseling center for people suffering from stress or anxiety, a desirable overall score would emphasize minimizing sudden or unexpected surprises over reaching a destination floor quickly. A weighted combination of a plurality of individual scores meeting that need could be (speed*0.05)+(acceleration*0.05)+(jerk*0.25)+(vibration*0.2)+(light*0.15)+(sound*0.15)+(temperature*0.1)+(signal strength*0.05). Relatively high weights of 25% assigned to jerk and 20% assigned to vibration give a high value to minimizing anxiety causing events during travel. Moderate weights of 15% for sound and light and 10% for temperature give a moderate value to providing a comfortable environment during travel. Low weights of 5% for speed, acceleration, and signal strength give a low value to both reaching a destination quickly and being able to receive calls during travel. Other embodiments varying the individual scores used and the weights assigned to them can provide for flexible application of such an overall score calculation in different contexts. Further variations on the calculation and weights assigned to hybrid score groupings will be apparent to one of ordinary skill in the art.

In some embodiments, the software tool will not generate any hybrid or composite scoring, and may instead simply calculate one or more individual scores for speed, acceleration, jerk, vibration, temperature, light, sound, signal strength, and/or other measurable attributes. The generation of hybrid or composite scoring will depend upon the particular implementation of the technology, as hybrid and composite scoring may offer a higher level summary of an elevator's performance, but may also include subjective or arbitrary weights or manipulation of the data. In contrast, calculating individual scores may offer a more objective view of an elevator's performance, as the individual scores are less prone to subjective or arbitrary manipulation when considered in isolation.

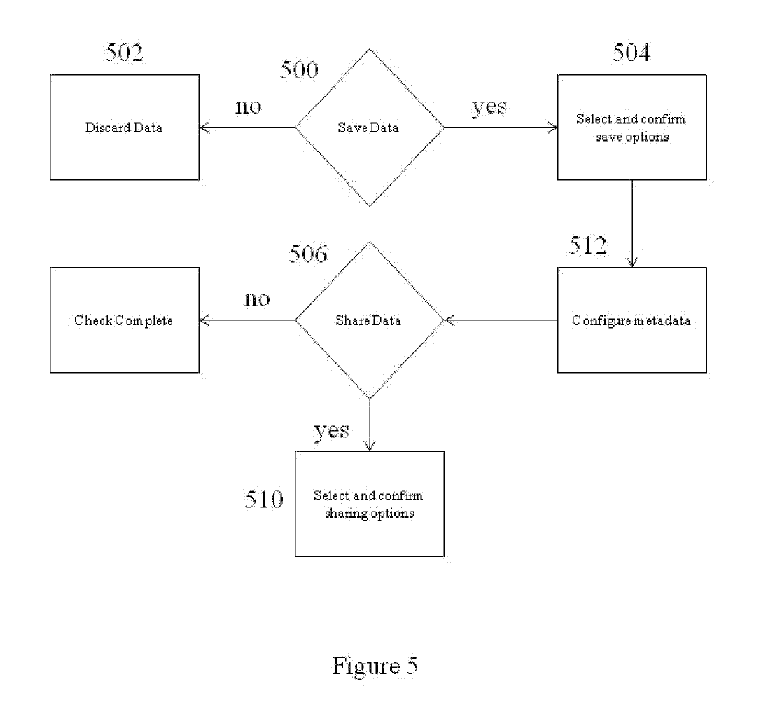

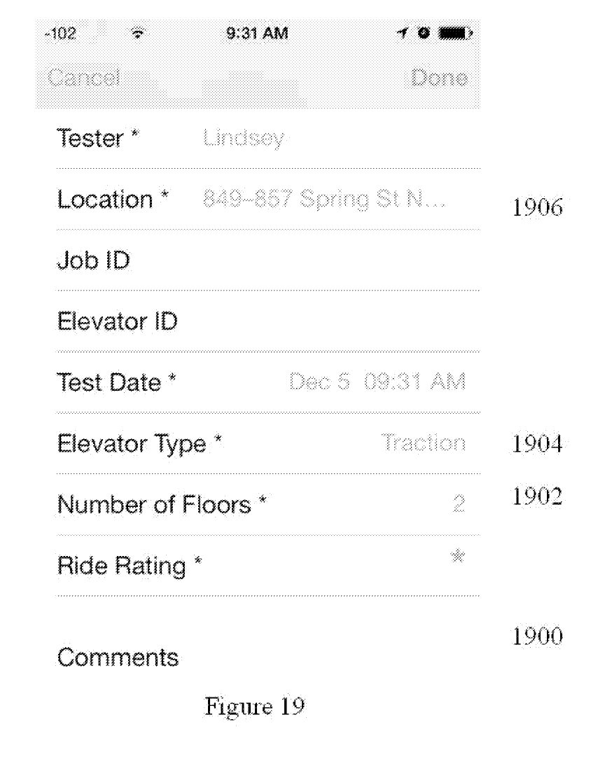

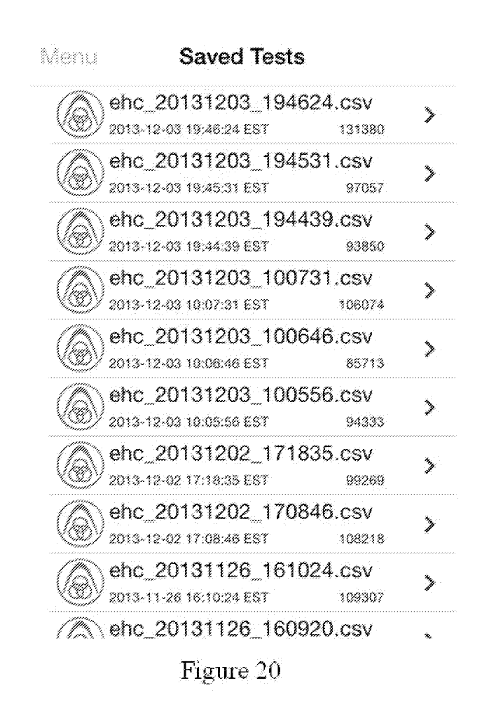

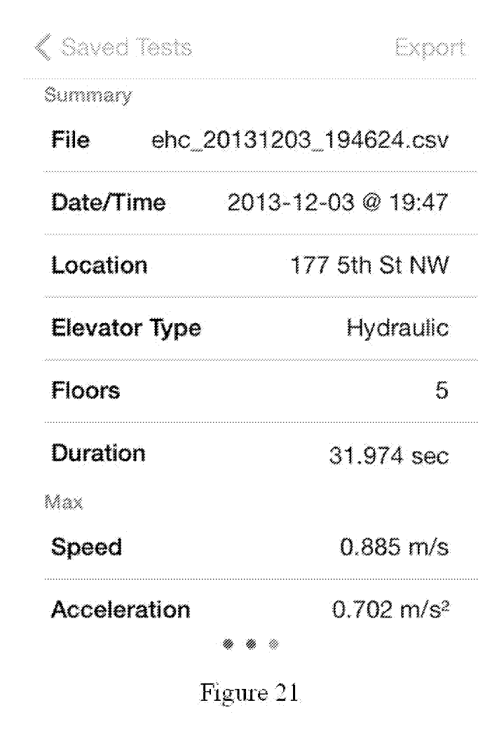

Turning now to FIG. 5, that figure shows a series of steps that a software tool can perform using a set of data generated by the software tool. Once the software tool has calculated the set of scores (104) that it is configured (100) to generate, a user can choose to save the data (500). If a user decides not to save the data, the data can be discarded (502). If a user decides to save the data, an interface will be displayed via the device whereby a user can select and confirm save options (504) and configure the metadata (512) associated with the test. FIG. 19 shows an example of an interface that could be used to configure metadata (512). Within this interface, a user can enter comments (1900) on the test, the number of floors (1902) served by the elevator, the type (1904) of elevator, the location (1906) of the elevator, or other data that would be useful to associate with the test data. FIG. 20 shows an example of an interface that could be used to save and browse data (504). Saved data (504) could be identified by file name and date of creation and a user could use such an interface to browse through one or more saved data (504) for review. FIG. 21 shows an example of an interface that could be used to review saved data (504), listing metadata and raw data associated with the saved data (504).

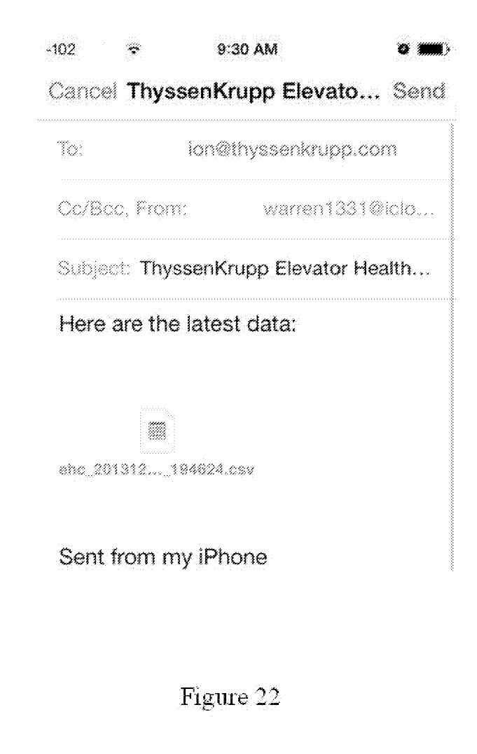

Once data has been saved (504) to the device, a user may choose to share the data (506). FIG. 22 shows an example of an interface that could be used to share saved data (504) via email. Using such an interface, a user could share saved data (510) with an installer, technician, or manufacturer via the internet. This method of sharing is an example only, as in some embodiments the saved data could be shared (510) by another wireless communication method such as Bluetooth, near field communication, or text message, or via a wired communication method such as universal serial bus or memory card. In an alternative embodiment, shared data could be submitted to an analytics database by a user or by an installer, technician or manufacturer receiving shared data from a user. A plurality of shared data sets could be analyzed by queries against the analytics database to produce meaningful data. For example, selecting from all available shared data sets where the elevator type is Model A, where a passenger comfort score is less than or equal to 50, and sorting by location of test, could provide a result set indicating that a high number of Model A elevators are performing poorly as to passenger comfort in a certain state or region. Based on this data, a manufacturer could provide additional training to technicians in that area or could revise maintenance recommendations and procedures for that area. Other queries and uses for such an analytics database will be apparent to one of ordinary skill in the art in light of this disclosure.

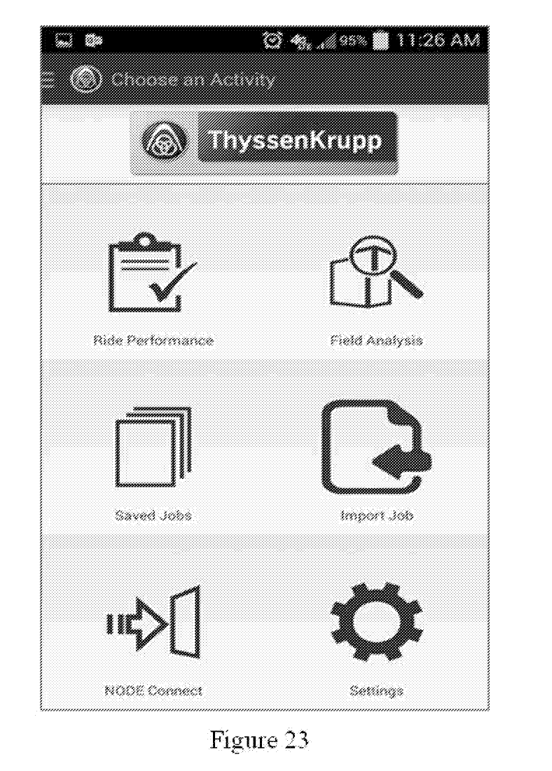

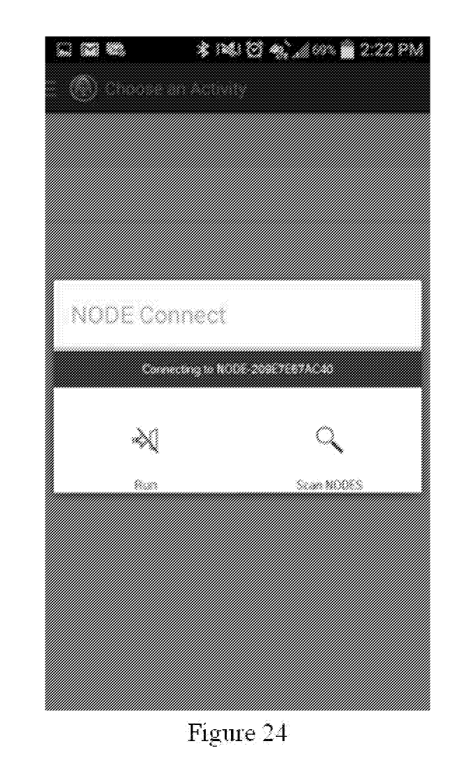

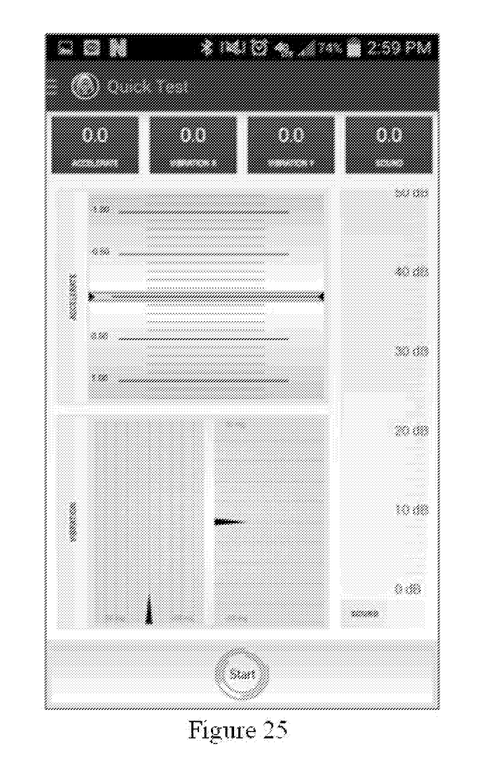

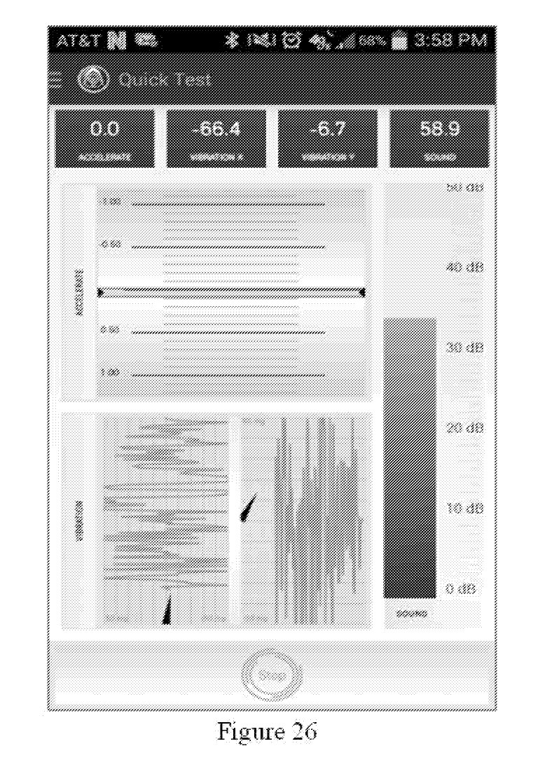

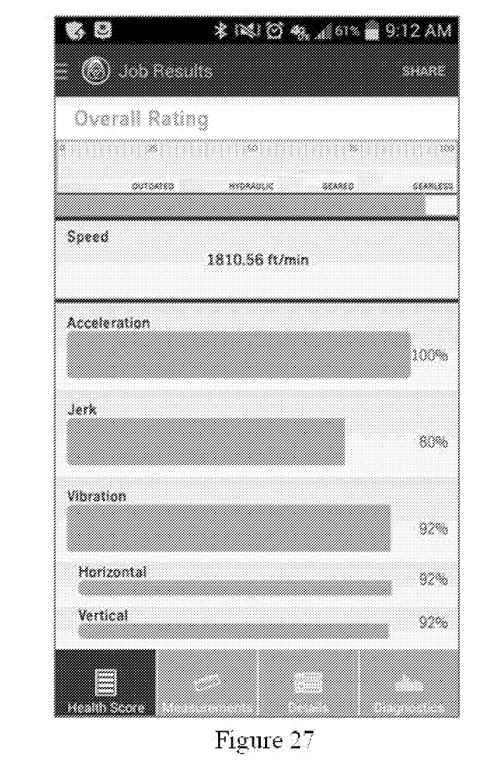

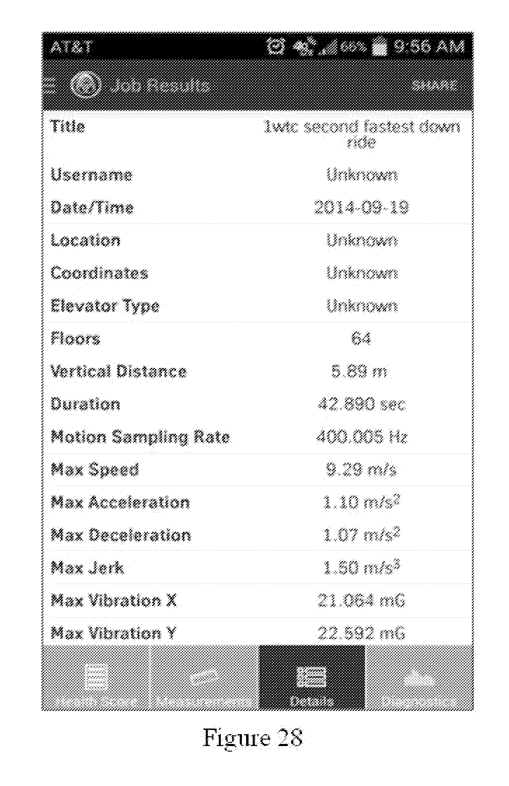

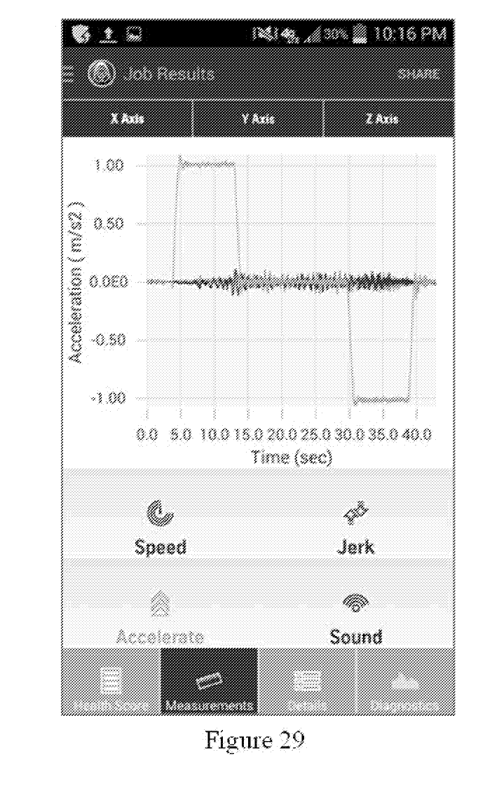

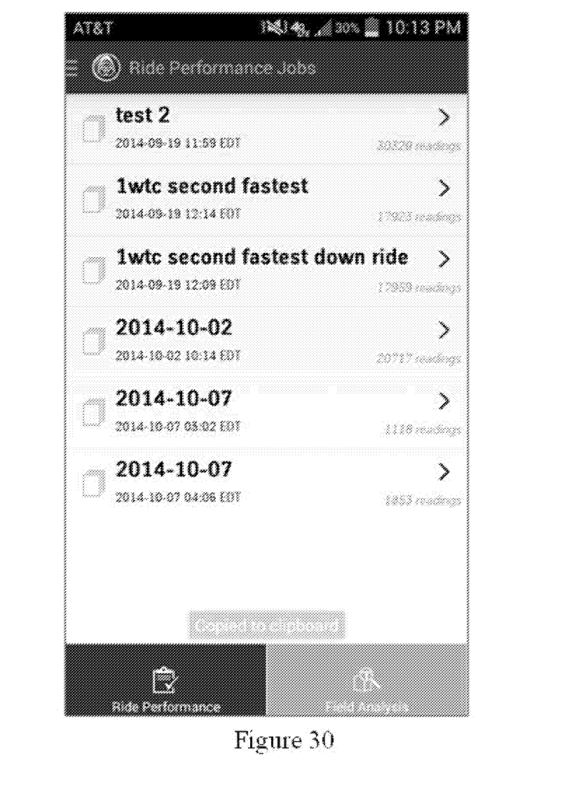

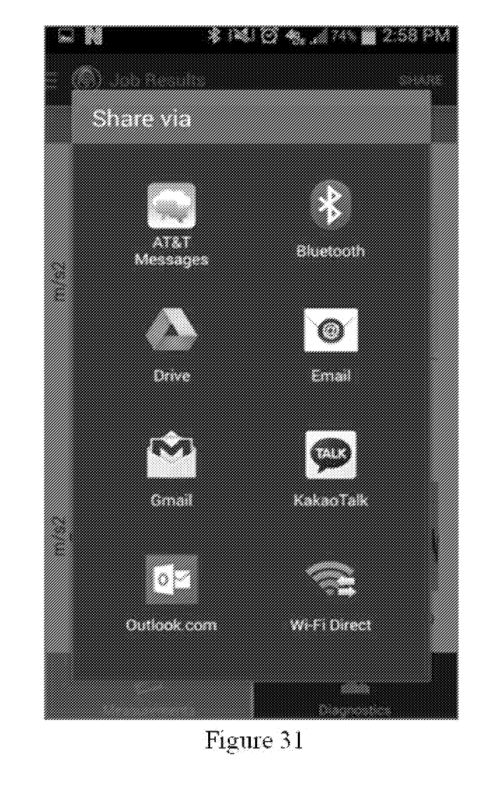

FIGS. 23-31 show alternate embodiments of interfaces for preparing, performing, viewing, and communicating the results of an elevator health check. FIG. 23 shows an example of an interface that could be used to select functionality, such as performance of a health check, review of health check data, connection to a peripheral sensor, and configuration of settings. FIG. 24 shows an example of an interface that could be used to identify and connect to a nearby peripheral sensor, allowing the sensor capabilities of the peripheral sensor to be used rather than relying entirely on the capabilities of the user device. FIG. 25 shows an interface that could be used to initiate a health check, while FIG. 26 shows the same interface during the performance of a health check. FIG. 27 shows an interface that could be used to view individual scores generated by a health check, including individual scores generated for speed, acceleration, jerk, and vibration. FIG. 28 shows an interface that could be used to view information generated by a health check other than individual scores, including date of check, location of check, coordinates of check, elevator type or characteristics, number of floors serviced by elevator car, vertical distance traveled, duration of test, sampling rate, maximum speed, maximum acceleration, maximum deceleration, maximum jerk, maximum horizontal vibration, maximum vertical vibration, and other information. FIG. 29 shows an interface that could be used to view health check information in graph form, showing the measured acceleration over the time of the test. While acceleration is shown, one or more graphs could be used to show parameter over time measurements on a variety of measurements including speed, jerk, vibration, sound, signal, or other measured parameters. FIG. 30 shows an interface that could be used to review and select, for viewing or communication, data of previously performed health checks. FIG. 31 shows an interface that could be used to communicate a selected health check data to another party via email, Wi-Fi, Bluetooth, cloud storage, or other methods.

Further variations on, features for, and applications of the inventors' technology will be immediately apparent to, and could be practiced without undue experimentation by, those of ordinary skill in the art in light of this disclosure. Accordingly, the protection accorded by this document, or by any related document, should not be limited to the material explicitly disclosed herein. Rather, such protection should be understood as being defined by the claims in such document, when the terms in those claims which are identified as having definitions set forth under an “Explicit Definitions” heading are interpreted as having those definitions, and all other terms are given their broadest reasonable interpretation as set forth in a general purpose dictionary. To the extent this disclosure or the disclosure of such related document, could be treated as providing a narrower definition, the explicit definitions, or the broadest reasonable interpretation as provided in a general purpose dictionary, shall control.

### EXPLICIT DEFINITIONS

When referred to in the claims, a statement that something is “based on” something else should be understood to mean that something is determined at least in part by the thing that it is indicated as being “based on.” When something is required to be completely determined by a thing, it will be described as being “based EXCLUSIVELY on” the thing.

When referred to in the claims, “calculating” should be understood to refer to the act of determining or ascertaining a thing by mathematical, formal logical, or algorithmic methods.

When referred to in the claims, “computer” should be understood to refer to a device or group of devices that is capable of performing one or more logical and/or physical operations on data to produce a result.

When referred to in the claims, “computer executable instructions” should be understood to refer to data that can be used to specify physical or logical operations which can be performed by a computer.

When referred to in the claims, “computer readable medium” should be understood to refer to any object, substance, or combination of objects or substances, capable of storing data or instructions in a form in which they can be retrieved and/or processed by a device. A computer readable medium should not be limited to any particular type or organization, and should be understood to include distributed and decentralized systems however they are physically or logically disposed, as well as storage objects of systems which are located in a defined and/or circumscribed physical and/or logical space. A reference to a “computer readable medium” being “non-transitory” should be understood as being synonymous with a statement that the “computer readable medium” is “tangible”, and should be understood as excluding intangible transmission media, such as a vacuum through which a transient electromagnetic carrier could be transmitted. Examples of “tangible” or “non-transitory” “computer readable media” include random access memory (RAM), read only memory (ROM), hard drives and flash drives.

When referred to in the claims, “configuring” should be understood to refer to providing the computer with specific data (which may include instructions) which can be used in performing the specific acts the computer is being “configured” to do. For example, installing Microsoft WORD on a computer “configures” that computer to function as a word processor, which it does using the instructions for Microsoft WORD in combination with other inputs, such as an operating system, and various peripherals (e.g., a keyboard, monitor, etc.).

When referred to in the claims, a “database” should be understood to refer to a collection of data stored on a computer readable medium in a manner such that the data can be retrieved by a computer. The term “database” can also be used to refer to the computer readable medium itself (e.g., a physical object which stores the data).

When referred to in the claims, a “set” should be understood to refer to a number, group, or combination of zero or more things of similar nature, design, or function.

When referred to in the claims, “determining” should be understood to refer to the act of generating, selecting or otherwise specifying something. For example, to obtain an output as the result of analysis would be an example of “determining” that output. As a second example, to choose a response from a list of possible responses would be a method of “determining” a response.

When referred to in the claims, “displaying” should be understood to refer to the act of providing the thing “displayed” in a visually perceptible form. It should be understood that, in the context of this disclosure, “displaying” refers not only to actually physically presenting a thing on a screen, but also to causing that thing to be presented (e.g., by sending instructions from a local CPU, or by sending information over a network which causes a thing to be “displayed”).

We claim:

1. A system for measuring and quantifying performance characteristics of elevator operation, the system comprising:
a mobile device; and
one or more sensors;
wherein:
the one or more sensors are adapted to gather operation data by measuring one or more characteristics of an elevator car while the elevator car is in motion; and
the mobile device is configured to:
create a set of elevator performance data based upon the operation data;
create a set of elevator performance scores based upon the elevator performance data; and
display the set of elevator performance scores.

2. The system of claim 1, wherein:
the one or more sensors comprises an accelerometer configured to capture acceleration data;
the operation data comprises the acceleration data;
the set of elevator performance data comprises a velocity value;
the set of elevator performance scores comprises a velocity score;
the mobile device is configured to:
determine the velocity value based on the acceleration data;
determine the velocity score based on a relationship between the velocity value and a velocity target of between 7 m/s and 12 m/s in which:
the velocity score increases polynomially between 0 m/s and a velocity less than the velocity target; and
the velocity score increases logarithmically from the velocity less than the velocity target.

3. The system of claim 2, wherein:
the velocity less than the velocity target is 2.5 m/s;
the velocity target is 10 m/s;
the velocity score is calculated as V_{score}=−7*Vᵥₐₗᵤₑ²+45*Vᵥₐₗᵤₑ if the velocity value is less than or equal to the velocity less than the velocity target;
the velocity score is calculated as V_{score}=50*log(Vᵥₐₗᵤₑ)+50 if the velocity value is greater than the velocity less than the velocity target;
V_{score} is defined as the velocity score; and
Vᵥₐₗᵤₑ is defined as the velocity value.

4. The system of claim 1, wherein:
the one or more sensors comprises an accelerometer configured to capture acceleration data;
the operation data comprises the acceleration data;
the set of elevator performance data comprises a jerk value;
the set of elevator performance scores comprises a jerk score;
the mobile device is configured to:
determine the jerk value based on the acceleration data; and
determine the jerk score based on a relationship between the jerk value and a jerk target of between 2 m/s³ and 3 m/s³ in which:
the jerk score decreases linearly between 0 m/s³ and the jerk target; and
the jerk score decreases exponentially from the jerk target.

5. The system of claim 4, wherein:
the jerk target is 2.44 m/s³
the jerk score is calculated as J_{score}=100−12.3*Jᵥₐₗᵤₑ if the jerk value is less than or equal to the jerk target
the jerk score is calculated as J_{score}=27000*ê(−2.45*Jᵥₐₗᵤₑ) if the jerk value is greater than the jerk target;
e is the mathematical constant which is the base of the natural logarithm;
J_{score} is defined as the jerk score; and
Jᵥₐₗᵤₑ is defined as the jerk value.

6. The system of claim 1, wherein:
the one or more sensors comprises an accelerometer configured to capture acceleration data;
the operation data comprises the acceleration data;
the set of elevator performance data comprises a vibration value;
the set of elevator performance scores comprises a vibration score;
the mobile device is configured to:
determine the vibration value based on the acceleration data; and
determine the vibration score based on a relationship between the vibration value and a vibration target of between 0 milli-g and 15 milli-g in which the vibration score decreases exponentially from the vibration target.

7. The system of claim 6 wherein:
the vibration score is calculated as V_{score}=733.15*ê(−11.3*Vᵥₐₗᵤₑ);
e is the mathematical constant which is the base of the natural logarithm;
V_{score} is defined as the vibration score; and
Vᵥₐₗᵤₑ is defined as the vibration value.

8. The system of claim 1, wherein:
the one or more sensors comprises an accelerometer configured to capture acceleration data;
the operation data comprises the acceleration data;
the set of elevator performance data comprises an acceleration value;
the set of elevator performance scores comprises an acceleration score;
the mobile device is configured to:
determine the acceleration value based on the acceleration data; and
determine the acceleration score based on a relationship between the acceleration value and an acceleration target of between 0.954 m/s² and 1.166 m/s² in which the acceleration score increases linearly from 0 to the acceleration target and decreases exponentially from the acceleration target.

9. The system of claim 8, wherein:
the acceleration target is a range from 0.954 m/s² to 1.166 m/s²;
the acceleration score is calculated as A_{score}=104.8*Aᵥₐₗᵤₑ if the acceleration value is less than 0.954 m/s²;
the acceleration score is calculated as A_{score}=100 if the acceleration value is 0.954 m/s² to 1.166 m/s²;
the acceleration score is calculated as A_{score}=1400*ê(−2.25*Aᵥₐₗᵤₑ) if the acceleration value is greater than 1.166 m/s²;
A_{score} is defined as the acceleration score; and
Aᵥₐₗᵤₑ is defined as the acceleration value.

10. The system of claim 1, wherein:
the one or more sensors comprises an accelerometer;
the accelerometer is configured to:
automatically initiate collection of operation data based on detection of a first non-gravitational acceleration;
automatically terminate collection of operation data based on detection of a second non-gravitational acceleration.

11. The system of claim 1, wherein:
the one or more sensors comprises a microphone configured to capture sound data;
the operation data comprises the sound data;
the set of elevator performance data comprises a sound value;
the set of elevator performance scores comprises a sound score;
the mobile device is configured to:
determine the sound value based on the sound data; and
determine the sound score based on a relationship between the sound value and a sound target of between 20 dBA and 40 dBA in which the sound score decreases linearly from the sound target.

12. The system of claim 11, wherein:
the sound score is calculated as S_{score}=−2*Sᵥₐₗᵤₑ+160;
S_{score} is defined as the sound score; and
Sᵥₐₗᵤₑ is defined as the sound value.

13. The system of claim 1, wherein:
the one or more sensors comprises a first set of sensors, wherein each sensor from the first set of sensors is integrated with the mobile device;
the one or more sensors comprises a second set of sensors, wherein each sensor from the second set of sensors is separate from the mobile device;
the set of operation data comprises data for each of a set of types of data consisting of:
acceleration data;
ambient light data;
barometric pressure data;
cellular signal strength data; and
temperature data;
the set of elevator performance data comprises a set of elevator performance values;
the mobile device is configured to:
determine each performance value from the set of elevator performance values based on one or more types of data from the set of operation data; and
for each type of data on which the determination of a performance value is based, use operation data from the first set of sensors when that type of operation data is not available from the second set of sensors, otherwise, use operation data from the second set of sensors.

14. A method for measuring and quantifying performance characteristics of elevator operation, the method comprising:
while an elevator car is in motion, gathering, with one or more sensors, operation data by measuring one or more characteristics of the elevator car;
storing the operation data in the memory of a mobile device;
determining, by using a processor comprised by the mobile device to execute a set of instructions stored in the memory of the mobile device:
a set of elevator performance data based on the operation data; and
a set of elevator performance scores based on the set of performance data; and
displaying, on the mobile device, the set of elevator performance scores.

15. The method of claim 14, wherein determining the set of elevator performance scores comprises, for each score from the set of elevator performance scores, selecting a scoring formula to use in determining that score from a set of scoring formulae comprising:
a first velocity scoring formula in which a velocity score increases polynomially as a velocity value from the set of performance data increases linearly;
a second velocity scoring formula in which the velocity score increases logarithmically as the velocity value from the set of performance data increases linearly;
a first jerk scoring formula in which a jerk score decreases exponentially as a jerk value from the set of performance data increases linearly;
a second jerk scoring formula in which the jerk score decreases linearly as a jerk value from the set of performance data increases linearly;
a vibration scoring formula in which a vibration score decreases exponentially as a vibration value from the set of performance data increases linearly;
a first acceleration scoring formula in which an acceleration score increases linearly as an acceleration value from the set of performance data increases linearly;
a second acceleration scoring formula in which the acceleration score remains constant as the acceleration value from the set of performance data increases linearly;
a third acceleration scoring formula in which the acceleration score decreases exponentially as the acceleration value from the set of performance data increases linearly; and
a sound scoring formula in which a sound score decreases linearly as a sound value from the set of performance data increases linearly.

16. The method of claim 15, wherein:
for each score from the set of elevator performance scores, selecting the scoring formula to use in determining that score from the set of scoring formulae comprises the mobile device programmatically selecting the scoring formula to use in determining that score; and
each scoring formula from the set of scoring formulae is encoded in the memory of the mobile device.

17. The method of claim 14, wherein:
the one or more sensors comprises a sensor separate from the mobile device;
the sensor separate from the mobile device is adapted to reusably capture operation data for different elevator cars;
the method comprises, for each of at least two elevator cars, performing a set of acts comprising:
placing the sensor separate from the mobile device at a location for measuring at least one characteristic of that elevator car;
removing the sensor separate from the mobile device from the location for measuring at least one characteristic of that elevator car;
after placing the sensor separate from the mobile device at the location for measuring at least one characteristic of that elevator car and before removing the sensor separate from the mobile device from the location for measuring at least one characteristic of that elevator car:
causing that elevator car to travel within an elevator hoistway; and
gathering, while that elevator car is traveling, via the sensor separate from the mobile device at the location for measuring at least one characteristic of that elevator car, operation data;
and
communicating the operation data gathered via the sensor separate from the mobile device to the mobile device.

18. The method of claim 17, wherein:
for a first elevator car from the at least two elevator cars, placing the sensor separate from the mobile device at the location for measuring at least one characteristic of that elevator car comprises removably attaching the sensor to a cable in the hoistway for that elevator; and
for a second elevator car from the at least two elevator cars, placing the sensor separate from the mobile device at the location for measuring at least one characteristic of that elevator car comprises removably attaching the sensor to a location on the floor of the elevator car's interior.

19. The method of claim 14, wherein the method comprises:
automatically initiating the gathering of operation data based on detection of a first non-gravitational acceleration; and
automatically terminating the gathering of operation data based on detection of a second non-gravitational acceleration.

20. A system for measuring and quantifying performance characteristics of elevator operation, the system comprising:
a mobile phone; and
one or more reusable sensors;
wherein:
each of the one or more reusable sensors is adapted to:
gather operation data while an elevator car is moving; and
be either:
temporarily fixed to an interior location of the elevator car and removed from after the operation data is gathered; or
permanently installed on the interior or exterior of the elevator car;
the operation data that the plurality of sensors is adapted to gather while the elevator car is moving comprises:
noise; and
acceleration; and
the mobile phone is configured to perform a set of acts comprising:
receiving, via a wireless connection from the one or more reusable sensors, the operation data gathered while the elevator car is moving;
determining, from the operation data, a set of extrapolated data values comprising:
a jerk value, determined via a derivative of acceleration data from the operation data;
a velocity value, determined via integration of acceleration data from the operation data; and
a vibration value, determined via integration of the velocity value from the set of extrapolated data values;
determining one or more operation compliance values, wherein determining the one or more operation compliance values comprises determining, based on the operation data and the extrapolated data:
whether the jerk value is outside a first range;
whether a noise reading is outside a second range;
whether the velocity value is outside a third range;
whether an acceleration value is outside of a fourth range; and
whether the vibration value is outside of a fifth range;
based on the one or more determined operation compliance values, determine a set of performance scores for the elevator car, the set of performance scores comprising:
a jerk score;
a noise score;
a velocity score;
an acceleration score; and
a vibration score;
displaying the set of performance scores for a user; and
communicating the operation compliance values, the operation data, and the extrapolated data to a server for data trend analysis.
